(19) United States
(12) Patent Application Publication
(10) Pub. No.: US 2025/0130160 A1
(43) Pub. Date: Apr. 24, 2025

(54) MICROPARTICLE SORTING DEVICE AND MICROPARTICLE SORTING METHOD

(71) Applicant: SONY GROUP CORPORATION, TOKYO (JP)

(72) Inventors: MASAHIKO NAKAMURA, TOKYO (JP); MASAHIRO MATSUMOTO, TOKYO (JP); TATSUMI ITO, TOKYO (JP)

(21) Appl. No.: 18/835,784

(22) PCT Filed: Feb. 2, 2023
(86) PCT No.: PCT/JP2023/003337

§ 371 Date: Aug. 5, 2024

(30) Foreign Application Priority Data
Feb. 14, 2022 (JP) 2022-020206

(51) Int. Cl. G01N 15/149; G01N 15/10; G01N 15/1404; G01N 15/1429

(52) U.S. Cl. CPC G01N 15/149; G01N 15/1404; G01N 15/1429; G01N 2015/1028

(57) ABSTRACT

To provide a microparticle sorting device for optimizing an emulsion generation condition and a microparticle sorting condition. The present technology provides the microparticle sorting device including: a particle detection unit that detects microparticles in a first liquid flowing through a main flow path; a collection flow path that collects an emulsion in which a sorting-target microparticle among the microparticles and the first liquid are contained in a second liquid immiscible with the first liquid; an emulsion detection unit that detects light from the emulsion collected and/or microparticles contained in the emulsion by using different optical detection systems; and a control unit that controls collection of the emulsion into the collection flow path on the basis of information detected by the emulsion detection unit. Furthermore, the present technology also provides a microparticle sorting method in the microparticle sorting device.

### TECHNICAL FIELD

The present technology relates to a microparticle sorting device and a microparticle sorting method.

### BACKGROUND ART

Various microparticle sorting devices have been developed so far to sort a microparticle. For example, in a microparticle sorting system used in a flow cytometer, a laminar flow including sample liquid containing cells and sheath liquid is discharged from an orifice formed in a flow cell or a microchip. A predetermined vibration is applied to the laminar flow during discharge, whereby droplets are formed. A moving direction of the formed droplets is electrically controlled depending on whether or not a target microparticle is contained, and the target microparticle can be sorted.

A technology has also been developed for sorting a target microparticle in a microchip, without forming droplets as described above. For example, Patent Document 1 below describes “A method for optimizing a suction condition for a microparticle including: a number-of-particles counting step of detecting a time point when a microparticle passes through, at a predetermined position on a main flow path through which liquid containing the microparticle flows, sucking the microparticle from the main flow path to a microparticle suction flow path by the microparticle suction flow path with a predetermined suction force, and counting a number of microparticles sucked into the microparticle suction flow path; and a step of determining an elapsed time from passage through the predetermined position, with which suction by the microparticle suction flow path is to be performed, on the basis of a time from the time point when the microparticle passes through the predetermined position on the main flow path to when the suction is performed and the number of microparticles counted.” (claim 1). In order to enhance performance of sorting the microparticle, a method has been proposed for optimizing a suction condition for the microparticle.

### CITATION LIST

### Patent Document

Patent Document 1: WO 2018/216269 A

### SUMMARY OF THE INVENTION

### Problems to be Solved by the Invention

In a microparticle sorting device, it is desirable that sorting efficiency is as high as possible. However, the technology disclosed in Patent Document 1 described above is an emulsion detection system using scattered light detection (particularly forward-scattered light detection), and since it is not possible to distinguish between an emulsion containing a microparticle and an emulsion not containing a microparticle, the sorting efficiency decreases. For this reason, a microparticle sorting device is required that generates an appropriate emulsion containing a microparticle and has high sorting efficiency.

### Solutions to Problems

Thus, the present inventors have found that it is possible to achieve optimization of an emulsion generation condition and optimization of a microparticle sorting condition by using detection signals of different optical detection systems.

That is, the present technology provides
a microparticle sorting device including:
a particle detection unit that detects microparticles in a first liquid flowing through a main flow path;
a collection flow path that collects an emulsion in which a sorting-target microparticle among the microparticles and the first liquid are contained in a second liquid immiscible with the first liquid;
an emulsion detection unit that detects light from the emulsion collected and/or microparticles contained in the emulsion by using different optical detection systems; and
a control unit that controls collection of the emulsion into the collection flow path on the basis of information detected by the emulsion detection unit. The collection flow path can include:
a pressure chamber provided in the midway of the collection flow path; and
an actuator that operates at a time of sorting the microparticles and increases a volume of the pressure chamber by a certain amount.

The control unit can adjust a sorting delay time that is a time from detection of the microparticles in the particle detection unit to suction of the microparticles in the collection flow path, or a suction force that is strength of suction in the collection flow path, on the basis of information on light detected by the emulsion detection unit.

The actuator can be a piezoelectric element, and the suction force can be adjusted by a drive waveform of the piezoelectric element or a drive voltage of the piezoelectric element.

In the emulsion detection unit, at least one of the different optical detection systems can detect scattered light.

The scattered light can be any of forward-scattered light, back-scattered light, or side-scattered light.

In the emulsion detection unit, at least one of the different optical detection systems can detect fluorescence.

A plurality of pieces of the fluorescence detected by the optical detection systems can have an identical or a plurality of wavelengths.

The emulsion detection unit can detect information regarding the emulsion on the basis of forward-scattered light.

The emulsion detection unit can detect information regarding presence or absence of a microparticle in the emulsion on the basis of at least one of fluorescence, back-scattered light, or side-scattered light.

The control unit can change the sorting delay time, count the number of microparticles in the emulsion detected by the emulsion detection unit, and determine, as an optimal sorting delay time, a sorting delay time in which a counted number of the microparticles in the emulsion is a predetermined value.

A maximum value of the counted number of the microparticles in the emulsion can be set as the predetermined value.

The control unit can change the suction force, calculate a signal intensity of forward-scattered light detected by the emulsion detection unit, and determine a suction force having a predetermined signal intensity as an optimal suction force.

The signal intensity can be any of an area signal, a peak signal, and a width signal.

The control unit can change the suction force, count the number of the emulsions detected by the emulsion detection unit, and determine, as an optimal suction force, a suction force with which a counted number of the emulsions is a predetermined value.

The control unit can determine an optimal suction force on the basis of both a signal intensity of the forward-scattered light detected by the emulsion detection unit and a counted number of the emulsions.

The microparticle sorting device according to the present technology can further include an information processing unit that integrates information regarding the microparticles detected by the particle detection unit and information regarding microparticles in the emulsion detected by the emulsion detection unit.

The present technology provides
a microparticle sorting method including:
a particle detection step of detecting microparticles in a first liquid flowing through a main flow path;
a collection step of collecting an emulsion in which a sorting-target microparticle among the microparticles and the first liquid are contained in a second liquid immiscible with the first liquid;
an emulsion detection step of detecting light from the emulsion collected and/or microparticles contained in the emulsion by using different optical detection systems; and
a control step of controlling collection of the emulsion in the collection step on the basis of information detected in the emulsion detection step.

Furthermore, the present technology provides
a microparticle sorting method including:
an emulsion detection step of sucking a first liquid containing microparticles with a predetermined suction force by a collection flow path from a main flow path communicating with the collection flow path into the collection flow path, generating an emulsion in which a sorting-target microparticle among the microparticles and the first liquid are contained in a second liquid immiscible with the first liquid, and acquiring a signal intensity of light from the emulsion or counting the number of emulsions generated;
a suction force determination step of determining a suction force for sucking the first liquid into the collection flow path on the basis of the signal intensity acquired or the number of emulsions generated;
a number-of-particles counting step of sucking the first liquid containing the sorting-target microparticle among the microparticles into the collection flow path with the suction force determined in the suction force determination step and counting the number of the sorting-target microparticles sucked into the collection flow path; and
a step of determining a time at which suction is to be performed, on the basis of the number of the sorting-target microparticles counted, the step determining an elapsed time from passage through a predetermined position of the main flow path, the elapsed time being a time with which suction by the collection flow path is to be performed.

### BRIEF DESCRIPTION OF DRAWINGS

FIG. 1 is a diagram illustrating a configuration example of a microparticle sorting microchip used in a microparticle sorting device according to the present technology.

FIG. 2 is a schematic diagram illustrating a state in which a sample liquid containing microparticles and a sheath liquid form a laminar flow in a main flow path.

FIG. 3 is an enlarged view of an example of a particle sorting section.

FIG. 4 is a block diagram of an example of a control unit.

FIG. 5 is a schematic diagram illustrating a situation in a flow path in a case where a sorting-target microparticle is sucked into a collection flow path.

FIG. 6 is a diagram illustrating examples of a light irradiation unit, a particle detection unit, and an emulsion detection unit.

FIG. 7 is a graph illustrating a fluorescence signal and a forward-scattered light signal in a case where an emulsion containing a microparticle reaches an emulsion detection region.

FIG. 8 is a graph illustrating a fluorescence signal and a forward-scattered light signal in a case where the emulsion not containing the microparticle reaches the emulsion detection region.

FIG. 9 is a graph illustrating a fluorescence signal and a forward-scattered light signal in a case where the emulsion does not reach the emulsion detection region.

FIG. 10 is a flowchart of a microparticle sorting method according to a second embodiment of the present technology.

FIG. 11 is a diagram illustrating a position where passage of a microparticle is detected.

FIG. 12 is a diagram illustrating a region where a microparticle is sucked into the collection flow path in a case where suction is performed under a predetermined condition.

FIG. 13 is a diagram illustrating a region where a microparticle is sucked into the collection flow path in a case where suction is performed under a predetermined condition, and a graph illustrating the number of particles counted under the condition.

FIG. 14 is a flowchart of a microparticle sorting method according to a third embodiment of the present technology.

FIG. 15 is a diagram illustrating a region where a microparticle is sucked into the collection flow path in a case where suction is performed under a predetermined condition, and a graph illustrating the number of particles counted under the condition.

FIG. 16 is a diagram illustrating a region where a microparticle is sucked into the collection flow path in a case where suction is performed under a predetermined condition, and a graph illustrating the number of particles counted under the condition.

FIG. 17 is a diagram illustrating a region where a microparticle is sucked into the collection flow path in a case where suction is performed under a predetermined condition, and a graph illustrating the number of particles counted under the condition.

FIG. 18 is a flowchart of a microparticle sorting method according to a fourth embodiment of the present technology.

FIG. 19 is a flowchart of a microparticle sorting method according to a fifth embodiment of the present technology.

FIG. 20 is a graph illustrating the number of emulsions sucked into the collection flow path at various suction forces Dₙ.

FIG. 21 is a flowchart of a microparticle sorting method according to a sixth embodiment of the present technology.

### MODE FOR CARRYING OUT THE INVENTION

Hereinafter, preferred embodiments for implementing the present technology will be described. Note that embodiments hereinafter described are representative embodiments of the present technology, and the scope of the present technology is not limited only to them. Note that the present technology will be described in the following order.
1. First embodiment (microparticle sorting device)
   (1) Description of first embodiment
   (2) Example of microparticle sorting device
   (2-1) Configuration of device and sorting operation
2. Second embodiment (microparticle sorting method in microparticle sorting device)
   (1) Number-of-particles counting step S1001
   (2) Step S1002 of repeating number-of-particles counting step
   (3) Step S1003 of determining time at which suction should be performed
3. Third embodiment (microparticle sorting method in microparticle sorting device)
   (1) Second repeating step S1403 of repeating number-of-particles counting step
   (2) Step S1404 of determining time at which suction should be performed and/or suction force that should be applied
   (3) Preferred implementation of second repeating step S1403
4. Fourth embodiment (microparticle sorting method in microparticle sorting device)
   (1) Emulsion detection step S1801
   (2) Step S1802 of repeating emulsion detection step
   (3) Step S1803 of determining suction force
5. Fifth embodiment (microparticle sorting method in microparticle sorting device)
   (1) Emulsion counting step S1901
   (2) Step S1902 of repeating emulsion counting step
   (3) Step S1903 of determining suction force
6. Sixth embodiment (microparticle sorting method in microparticle sorting device)
   (1) Particle detection step S2101
   (2) Collection step S2102
   (3) Emulsion detection step S2103
   (4) Control step S2104

### 1. First Embodiment (Microparticle Sorting Device)

### (1) Description of First Embodiment

A microparticle sorting device according to the present technology includes: a particle detection unit that detects microparticles in a first liquid flowing through a main flow path; a collection flow path that collects an emulsion in which a sorting-target microparticle among the microparticles and the first liquid are contained in a second liquid immiscible with the first liquid; an emulsion detection unit that detects light from the emulsion collected and/or microparticles contained in the emulsion by using different optical detection systems; and a control unit that controls collection of the emulsion into the collection flow path on the basis of information detected by the emulsion detection unit.

Hereinafter, first, a configuration example will be described of a microparticle sorting device according to the present technology.

### (2) Example of Microparticle Sorting Device

### (2-1) Configuration of Device and Sorting Operation

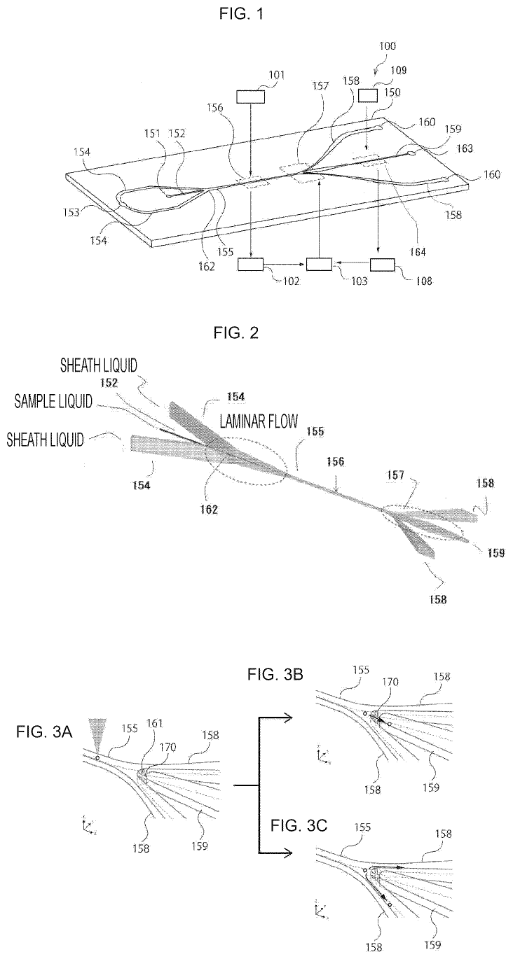

The microparticle sorting device according to the present technology may be configured as a device that sorts the sorting-target microparticle in a closed space, and for example, may be configured as a device that sorts the sorting-target microparticle by controlling a flow path in which the microparticles travel. FIG. 1 illustrates a configuration example of the microparticle sorting device according to the present technology. The figure also illustrates an example of a flow path structure of a microparticle sorting microchip (hereinafter also referred to as a “microchip”) attached to the device.

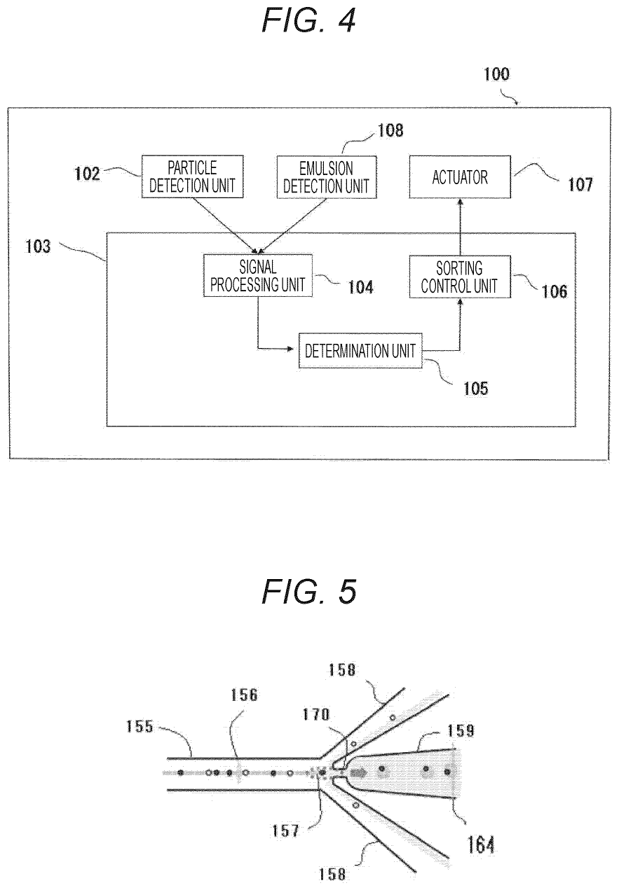

As illustrated in FIGS. 1 and 4, a microparticle sorting device 100 includes a first light irradiation unit 101, a particle detection unit 102, a second light irradiation unit 109, an actuator 107, an emulsion detection unit 108, and a control unit 103. The microparticle sorting device 100 further includes a microchip 150. The microchip 150 may be attached to the microparticle sorting device 100 in an exchangeable manner. As illustrated in FIG. 4, the control unit 103 can include a signal processing unit 104, a determination unit 105, and a sorting control unit 106.

Hereinafter, first, the microparticle sorting microchip 150 will be described, and next, while sorting processing by the microparticle sorting device 100 will be described, other components of the device will be described.

As illustrated in FIG. 1, the microparticle sorting microchip 150 is provided with a sample liquid inlet 151 and a sheath liquid inlet 153. From these inlets, a sample liquid including the first liquid containing the sorting-target microparticle and a sheath liquid including only the first liquid not containing the microparticles are introduced into a sample liquid flow path 152 and a sheath liquid flow path 154, respectively.

The microparticle sorting microchip 150 has a flow path structure in which the sample liquid flow path 152 through which the sample liquid flows and the sheath liquid flow path 154 through which the sheath liquid flows are merged at a merging section 162 to become a main flow path 155. As illustrated in FIG. 2, the sample liquid and the sheath liquid merge at the merging section 162, and, for example, a laminar flow is formed in which the periphery of the sample liquid is surrounded by the sheath liquid. Preferably, in the laminar flow, the microparticles are arrayed substantially in a line. As described above, in the present technology, the flow path structure forms a laminar flow including the microparticles flowing substantially in a line.

The laminar flow flows through the main flow path 155 toward a particle sorting section 157. Preferably, the microparticles flow in a line in the main flow path 155. As a result, in light irradiation in a particle detection region 156 described below, light generated by light irradiation to one microparticle and light generated by light irradiation to another microparticle can be easily distinguished from each other.

The microparticle sorting microchip 150 includes the particle detection region 156. In the particle detection region 156, the first light irradiation unit 101 performs light irradiation to a microparticle flowing through the main flow path 155, and the particle detection unit 102 detects light generated by the light irradiation. Depending on characteristics of the light detected by the particle detection unit 102, the determination unit 105 included in the control unit 103 determines whether the microparticle is a sorting-target microparticle. For example, the determination unit 105 can perform determination based on scattered light of any of forward-scattered light, side-scattered light, or back-scattered light, determination based on a plurality of pieces of fluorescence having the same or a plurality of wavelengths, or determination based on an image (for example, a dark field image and/or a bright field image, or the like).

The microparticle sorting microchip 150 illustrated in FIG. 1 includes the main flow path 155 through which microparticles flow, a collection flow path 159 in which the sorting-target microparticle among the microparticles is sorted and an emulsion is generated, and a disposal flow path 158 in which a non-sorting-target microparticle is disposed. The microparticle sorting microchip 150 is provided with the particle sorting section 157. An enlarged view of the particle sorting section 157 is illustrated in FIG. 3. As illustrated in FIG. 3A, the particle sorting section 157 includes a connection flow path 170 that connects the main flow path 155 and the collection flow path 159 to each other. As illustrated in FIG. 3B, a sorting-target microparticle flows to the collection flow path 159 through the connection flow path 170. As illustrated in FIG. 3C, a non-sorting-target microparticle flows into the disposal flow paths 158. A liquid supply flow path 161 capable of supplying the second liquid immiscible with the first liquid is connected in the vertical direction of the connection flow path 170. As described above, the microparticle sorting microchip 150 has a flow path structure including the main flow path 155, the disposal flow path 158, the collection flow path 159, the connection flow path 170, and the liquid supply flow path 161.

In the particle sorting section 157, the laminar flow having flowed through the main flow path 155 flows to the disposal flow path 158. Furthermore, in the particle sorting section 157, only in a case where the sorting-target microparticle flows, a flow to the collection flow path 159 is formed, and the microparticle is sorted. When the microparticle is sucked into the collection flow path 159, the sample liquid constituting the laminar flow or the sample liquid and the sheath liquid constituting the laminar flow can also flow into the collection flow path 159.

In order to prevent the non-sorting-target microparticle from entering the collection flow path 159, the liquid supply flow path 161 may be connected to the connection flow path 170 as illustrated in A of FIG. 3. The second liquid is introduced from the liquid supply flow path 161 to the connection flow path 170, and flows to both the main flow path 155 and the collection flow path 159. A flow is formed from the connection flow path 170 to the main flow path 155, whereby the non-sorting-target microparticle is prevented from entering the collection flow path 159.

A pressure chamber may be provided in the midway of the collection flow path 159. The collection flow path 159 may include an actuator that operates at a time of sorting the sorting-target microparticle, increases a volume of the pressure chamber by a certain amount, and generates a suction force for the sorting-target microparticle. Note that the actuator can reduce the volume of the pressure chamber by a certain amount to generate a discharge force. The actuator may be a piezoelectric element, and the suction force may be adjusted by a drive waveform of the piezoelectric element or a drive voltage of the piezoelectric element. Note that the collection flow path 159 itself may function as a pressure chamber. A pressure in the pressure chamber can be decreased or increased. A suction force that is a strength of the suction force is generated by reduction of the pressure in the pressure chamber, and the sorting-target microparticle is guided into the collection flow path 159. As described above, it becomes possible to sort only the microparticle by adjustment of the pressure in the pressure chamber.

In the microparticle sorting microchip 150 having such a flow path structure, in a case where the microparticle is sorted, a flow (hereinafter, also referred to as “flow at the time of microparticle sorting”) is formed proceeding from the main flow path 155 to the collection flow path 159 through the connection flow path 170. The flow is not formed except in a case where the microparticle is sorted. The pressure in the pressure chamber can be decreased to form the flow at the time of microparticle sorting. Due to the decrease in the pressure, a flow is formed stronger than the flow from the connection flow path 170 to the main flow path 155 generated by the flow of the second liquid from the liquid supply flow path 161, from the main flow path 155 toward the collection flow path 159, and as a result, the sorting-target microparticle is sorted into the collection flow path 159.

The inside of the collection flow path 159 is made to have a negative pressure, whereby the flow at the time of microparticle sorting can be formed. That is, the inside of the collection flow path 159 is made to have a negative pressure, whereby the microparticle is sucked into the collection flow path 159. The suction of the microparticle is performed at a time point when a predetermined time has elapsed since the microparticle passed through the particle detection region 156 in a case where the determination unit 105 included in the control unit 103 determines that the microparticle should be sorted on the basis of the light detected by the particle detection unit 102 in the particle detection region 156. In order to perform microparticle sorting with higher accuracy, it is necessary to optimize a time elapsed before the time point when the suction should be performed. That is, it is necessary to optimize the sorting delay time, which is the time from the detection of the microparticle in the particle detection unit 102 to the suction of the microparticle in the particle sorting section 157. In the connection flow path 170 included in the particle sorting section 157, the first liquid is contained in the second liquid, and an emulsion containing the microparticle and an emulsion not containing the microparticle are generated.

In a case where the microparticle is sucked into the collection flow path 159, together with the microparticle, the sample liquid including the first liquid containing the microparticle and/or the sheath liquid including only the first liquid without containing the microparticle are sucked into the collection flow path 159. A certain suction force or more is required for generating the emulsion. The size of the emulsion is changed by the suction force, and in a case where the applied suction force is too large, an amount of the sample liquid and/or the sheath liquid sucked into the collection flow path 159 together with the microparticle increases, and a density of the microparticle sorted decreases, which is not preferable. Furthermore, in a case where the suction force is too large, the emulsion is split, and a plurality of emulsions is generated by one suction, which is not preferable. On the other hand, in a case where the applied suction force is too small, a possibility increases that the microparticle is not sorted. For that reason, it is desirable to optimize the applied suction force, too.

As illustrated in FIG. 1, the microparticle sorting microchip 150 includes an emulsion detection region 164 located on the downstream side of the particle sorting section 157. In the emulsion detection region 164, the second light irradiation unit 109 performs light irradiation to the emulsion flowing through the collection flow path 159, and the emulsion detection unit 108 detects light generated by the light irradiation. Note that in a case of detection only with forward-scattered light, presence or absence of the emulsion and an emulsion size can be detected, but in an emulsified microparticle, scattered light is generated on the surface of the emulsion, and it is not possible to distinguish between the emulsion containing the microparticle and the emulsion not containing the microparticle. In order to detect the sorting-target microparticle in the emulsion, to detect a type (for example, a cell type) of the microparticle, and to detect the state (for example, life or death of a cell) of the microparticle, the emulsion detection unit 108 may preferably be a combination of forward-scattered light detection and fluorescence detection, a combination of forward-scattered light detection and side-scattered light detection, a combination of forward-scattered light detection and back-scattered light detection, a combination of forward-scattered light detection, side-scattered light detection, and the fluorescence detection, or a combination of forward-scattered light detection, back-scattered light detection, and the fluorescence detection.

A plurality of pieces of the fluorescence may have the same or a plurality of wavelengths. Depending on characteristics of the light detected by the emulsion detection unit 108, the determination unit 105 included in the control unit 103 determines whether the sorting-target microparticle is contained in the emulsion. For example, the determination unit 105 can perform determination based on the combination of the detections.

Hereinafter, a light irradiation unit, a particle detection unit, and an emulsion detection unit in the microparticle sorting device according to the present technology will be described. More specifically, the first light irradiation unit and the second light irradiation unit will be described as the light irradiation unit, a particle detection scattered light detection system and a particle detection fluorescence detection system will be described as the particle detection unit, and a collection count scattered light detection system and a collection count fluorescence detection system will be described as the emulsion detection unit.

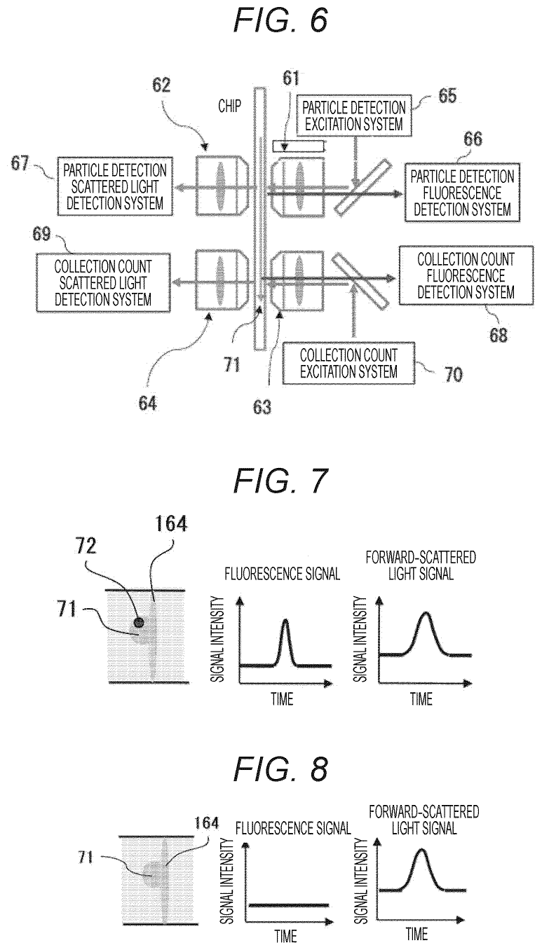

FIG. 6 is a diagram illustrating examples of the light irradiation unit, the particle detection unit, and the emulsion detection unit in the microparticle sorting device according to the present technology. FIG. 6 illustrates examples of a particle detection excitation system 65 as the first light irradiation unit, a sorting count excitation system 70 as the second light irradiation unit, a particle detection scattered light detection system 67 and a particle detection fluorescence detection system 66 as the particle detection unit, and a sorting count scattered light detection system 69 and a sorting count fluorescence detection system 68 as the emulsion detection unit.

The first light irradiation unit is the particle detection excitation system 65 for microparticle detection in a sample flow path, and emits light for fluorescence excitation to the microparticle flowing through the main flow path. The second light irradiation unit is the sorting count excitation system 70 for detection of the sorting-target microparticle in the collection flow path, and emits light for fluorescence excitation to the emulsion flowing through the collection flow path.

The first light irradiation unit and the second light irradiation unit emit light (for example, excitation light) to the microparticle flowing in the flow path in the microparticle sorting microchip. The light irradiation unit can include a light source that emits light and objective lenses 61, 62, 63, and 64 that condense excitation light on the microparticle flowing in the detection region. The light source may be appropriately selected by one skilled in the art depending on a purpose of an analysis, and may be, for example, a laser diode, an SHG laser, a solid-state laser, a gas laser, a high brightness LED, or a halogen lamp, or may be a combination of two or more of them. The light irradiation unit may include another optical element, as necessary, in addition to the light source and the objective lenses.

The particle detection unit can include the particle detection scattered light detection system 67 and the particle detection fluorescence detection system 66. Detection can be performed of scattered light and fluorescence generated by emission of light from the first light irradiation unit to the microparticle, by these detection systems. Determination of whether the microparticle should be sucked (sorted) can be performed by the determination unit 105 included in the control unit 103 on the basis of the detected scattered light and fluorescence. Furthermore, the passage of the microparticle through the predetermined position can be detected by the control unit 103 on the basis of the detected scattered light and fluorescence. Furthermore, calculation of a passing speed of the microparticle can be performed by the control unit 103 on the basis of the detected scattered light and fluorescence.

In the emulsion detection unit, at least one of the different optical detection systems can detect scattered light. The scattered light may be any of forward-scattered light, back-scattered light, or side-scattered light. Furthermore, in the emulsion detection unit, at least one of the different optical detection systems may detect fluorescence. A plurality of pieces of the fluorescence detected may have the same wavelength or a plurality of wavelengths.

The emulsion detection unit may detect information regarding the presence or absence of the emulsion, a shape of the emulsion, the number of emulsions, and the like on the basis of the forward-scattered light, and the emulsion detection unit may detect information regarding the presence or absence of a microparticle in the emulsion, a shape of the emulsion, the number of emulsions, and the like on the basis of the fluorescence, the back-scattered light, or the side-scattered light. Hereinafter, detection in the emulsion detection unit will be described in more detail.

In the emulsion detection unit, detection can be performed of scattered light and fluorescence generated by emission of light from the second light irradiation unit to the microparticle. The emulsion detection unit may detect a combination of forward-scattered light detection and fluorescence detection, a combination of forward-scattered light detection and side-scattered light detection, a combination of forward-scattered light detection and back-scattered light detection, a combination of forward-scattered light detection, side-scattered light detection, and fluorescence detection, and a combination of forward-scattered light detection, back-scattered light detection, and fluorescence detection. In the emulsion detection unit, for example, an emulsion is detected using forward-scattered light, and a sorted microparticle is detected using fluorescence. Note that, in a case where only the sorted microparticles is counted (only optimization of a sorting time (suction start time) is performed), the scattered light detection system does not have to be provided. In the forward-scattered light detection, the emulsion size can be detected, and in the side-scattered light detection or the back-scattered light detection, the microparticle in the emulsion can be detected by detection of the scattered light generated in the emulsion.

The particle detection unit and the emulsion detection unit detect scattered light and/or fluorescence generated from the microparticle by light irradiation with the first light irradiation unit and the second light irradiation unit. The detection unit can include a condensing lens that condenses the fluorescence and/or scattered light generated from the microparticle and a detector. As the detector, a PMT, a photodiode, a CCD, a CMOS and the like may be used, but the detector is not limited thereto. The detection unit may include another optical element, as necessary, in addition to the condensing lens and the detector. The detection unit can further include, for example, a spectroscopic unit. Examples of optical components that constitute the spectroscopic unit include a grating, a prism, and an optical filter, for example. The spectroscopic unit can detect, for example, light having a wavelength that should be detected separately from light having other wavelengths. The detection unit can convert the detected light into an analog electric signal by photoelectric conversion. The detection unit can further convert the analog electric signal into a digital electric signal by AD conversion.

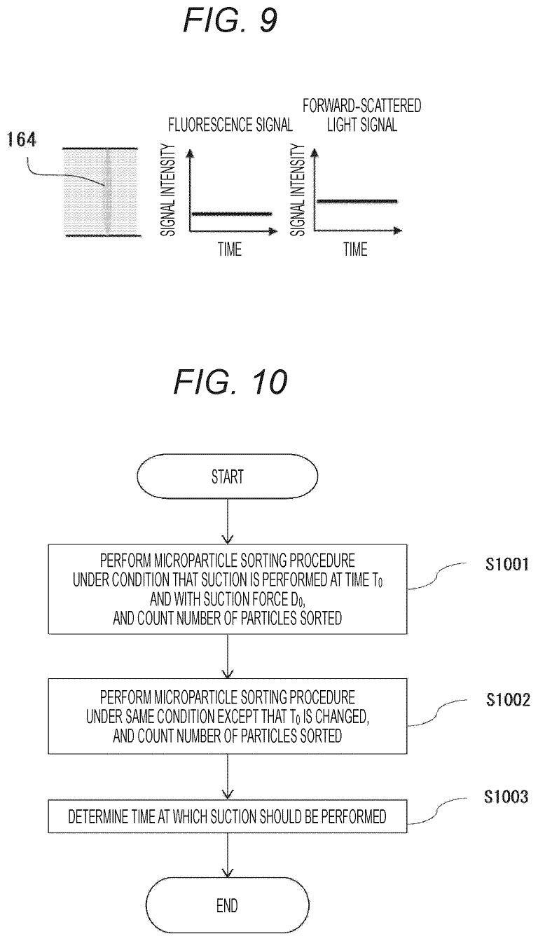

FIG. 7 is a graph illustrating a fluorescence signal and a forward-scattered light signal in a case where an emulsion 71 containing a microparticle 72 reaches the emulsion detection region 164. FIG. 8 is a graph illustrating a fluorescence signal and a forward-scattered light signal in a case where the emulsion 71 not containing the microparticle 72 reaches the emulsion detection region 164. FIG. 9 is a graph illustrating a fluorescence signal and a forward-scattered light signal in a case where the emulsion 71 does not reach the emulsion detection region 164. As illustrated in FIGS. 7 and 8, in the forward-scattered light detection by light irradiation, scattered light is generated on the surface of the emulsion, there is a peak value of signal intensity, and the emulsion containing the microparticle and the emulsion not containing the microparticle cannot be distinguished from each other. On the other hand, in the fluorescence detection, there is no peak value of signal intensity in the emulsion not containing the microparticle, whereas there is a peak value of signal intensity in the emulsion containing the microparticle, and it is possible to distinguish between the emulsion containing the microparticle and the emulsion not containing the microparticle. As illustrated in FIG. 9, in a case where the emulsion does not reach the emulsion detection region 164, there is no peak value of signal intensity in both the fluorescence signal and the forward-scattered light signal.

As illustrated in FIG. 6, emission of light to the microchip from the first light irradiation unit and the second light irradiation unit can be performed through the objective lenses. A numerical aperture (NA) of each objective lens can be preferably 0.1 to 1.5, more preferably 0.5 to 1.0.

Furthermore, the forward-scattered light generated by emission of light by the first light irradiation unit and the second light irradiation unit can be detected by the forward-scattered light detection system after the passage through the objective lenses. A numerical aperture (NA) of each objective lens can be preferably 0.05 to 1.0, more preferably 0.1 to 0.5. Furthermore, the light irradiation position may be present within a field of view of these objective lenses, and preferably both the light irradiation position and a branch portion can be present.

By the sorting operation of the microparticle sorting device according to the present technology, an emulsion containing the second liquid as a dispersion medium and the first liquid as a dispersoid is formed in the collection flow path. FIG. 5 is a schematic diagram illustrating a situation in the flow path in a case where the sorting-target microparticle is sucked into the collection flow path.

Kinematic viscosities of the first liquid and the second liquid at 25° C. can be, for example, preferably 0.3 cSt to 5 cSt, more preferably 0.4 cSt to 4 cSt, and still more preferably 0.5 cSt to 3 cSt. The kinematic viscosity of the second liquid is preferably 1/1000 to 1000 times, more preferably 1/100 to 100 times, still more preferably 1/10 to 10 times, still more preferably ⅕ to 5 times, and particularly preferably ½ to 2 times the kinematic viscosity of the first liquid. In the present technology, it is preferable that the kinematic viscosities of the first liquid and the second liquid are substantially the same as each other. As a result, the emulsion is easily formed.

Densities of the first liquid and the second liquid at 25° C. both can be, for example, preferably 0.5 g/cm³ to 5 g/cm³, more preferably 0.6 g/cm³ to 4 g/cm³, and still more preferably 0.7 g/cm³ to 3 g/cm³.

Furthermore, the density of the second liquid is preferably 1/100 to 100 times, more preferably 1/10 to 10 times, still more preferably ⅕ to 5 times, and particularly preferably ½ to 2 times the density of the first liquid. In the present technology, it is preferable that the densities of the first liquid and the second liquid are substantially the same as each other. As a result, the emulsion is easily formed.

The first liquid and the second liquid have the above physical properties, whereby the emulsion is easily formed in the collection flow path. Furthermore, due to such physical properties, these liquids easily flow in a microflow path.

In one implementation of the present technology, the first liquid may be a hydrophilic liquid, and the second liquid may be a hydrophobic liquid. In this implementation, an emulsion containing the hydrophobic liquid as a dispersion medium and the hydrophilic liquid as a dispersoid can be formed in the collection flow path. For example, it is desirable that a biological particle such as a cell is present in a state of being contained in the hydrophilic liquid such as a buffer or a culture solution. For that reason, this implementation is suitable for collecting microparticles, particularly biological particles, more particularly cells, which are desired to be present in the hydrophilic liquid.

The hydrophilic liquid includes, for example, water and a liquid miscible with water. For example, the hydrophilic liquid may be a liquid including, as a main component, one or a mixture of two or more selected from a group consisting of water, a hydrophilic alcohol, a hydrophilic ether, ketone, a nitrile-based solvent, dimethyl sulfoxide, and N,N-dimethylformamide. In the present specification, the main component refers to a component that accounts for, for example, 50 mass % or more, particularly 60 mass % or more, more particularly 70 mass % or more, and still more particularly 80 mass % or more, 85 mass % or more, or 90 mass % or more of the liquid. Examples of the hydrophilic alcohol include ethanol, methanol, propanol, and glycerin. Examples of the hydrophilic ether include tetrahydrofuran, polyethylene oxide, and 1,4-dioxane. Examples of the ketone include acetone and methyl ethyl ketone. Examples of the nitrile-based solvent include acetonitrile.

The hydrophilic liquid may be preferably a liquid containing water as a main component, and may be, for example, water, an aqueous solution, or an aqueous dispersion. The hydrophilic liquid may be, for example, the sheath liquid and/or the sample liquid. The hydrophilic liquid is preferably a hydrophilic liquid that does not adversely affect microparticles (for example, a biological particle, particularly, a cell).

The hydrophilic liquid may be, for example, a liquid containing a biological molecule. The biological molecule may be, for example, one or a combination of two or more selected from amino acids, peptides, and proteins.

Furthermore, the hydrophilic liquid may contain, for example, a surfactant, particularly a nonionic surfactant. Examples of the nonionic surfactant include a triblock copolymer of polyethylene oxide and polypropylene oxide, and the triblock copolymer is also referred to as a poloxamer or Pluronic (registered trademark)-based surfactant. A more specific example of a Pluronic (registered trademark)-based surfactant is Pluronic (trademark) F68.

Examples of the hydrophilic liquid include, but are not limited to, a culture solution and a buffer. The buffer is preferably a good buffer.

The culture solution is used as the hydrophilic liquid, whereby a cell sorted as the sorting-target microparticle can be cultured while being held in an emulsion particle.

Furthermore, the hydrophilic liquid (particularly, the sheath liquid) contains a cell stimulating component, whereby the cell sorted as the sorting-target microparticle can be stimulated while being held in the emulsion particles. Moreover, characteristics (for example, morphology, and the like) of the stimulated cell can also be observed by a microscope or the like.

Furthermore, the hydrophilic liquid (for example, the sheath liquid or the sample liquid) may include an assay system that enables observation of a response of cell stimulation. By the assay system, the response from the cell sorted as the sorting-target microparticle can be detected, for example, optically while the cell is held in the emulsion particle. The assay system is preferably a wash-free assay system, and for example, a system using fluorescence resonance energy transfer (FRET), bioluminescence resonance energy transfer (BRET), or the like is preferable.

As described above, in the present technology, in a case where the microparticle is a biological particle (particularly, a cell), it is possible to perform various analyses of a single biological particle (particularly, single cell analysis, for example, single cell imaging).

The density of the hydrophilic liquid at 25° C. can be, for example, preferably 0.5 g/cm³ to 5 g/cm³, more preferably 0.6 g/cm³ to 4 g/cm³, and still more preferably 0.7 g/cm³ to 3 g/cm³.

The kinematic viscosity of the hydrophilic liquid at 25° C. can be, for example, preferably 0.3 cSt to 5 cSt, more preferably 0.4 cSt to 4 cSt, and still more preferably 0.5 cSt to 3 cSt.

The hydrophilic liquid has the above physical properties, whereby the hydrophilic liquid easily flows in the microflow path, and an emulsion is easily formed in the collection flow path.

The hydrophobic liquid may be any liquid selected from liquids that are immiscible with the hydrophilic liquid. The hydrophobic liquid may be, for example, a liquid including, as a main component, one or a mixture of two or more selected from a group consisting of an aliphatic hydrocarbon, a fluorine-based oil, a low molecule or polymer containing a fluorine atom, a silicone oil, an aromatic hydrocarbon, an aliphatic monohydric alcohol (for example, n-octanol or the like), and a fluorinated polysaccharide.

The aliphatic hydrocarbon is preferably an aliphatic hydrocarbon having 7 or more and 30 or less carbon atoms. The number of carbon atoms is 7 or more and 30 or less, whereby the kinematic viscosity of the hydrophobic liquid is suitable for flowing in the microflow path. Examples of the aliphatic hydrocarbon include mineral oils; for example, oil derived from animals and plants such as squalane oil and olive oil; for example, a paraffinic hydrocarbon having 10 to 20 carbon atoms such as decane and hexadecane; and an olefin-based hydrocarbon having 10 to 20 carbon atoms.

In the present technology, from a viewpoint of good immiscibility with the hydrophilic liquid, the hydrophobic liquid is preferably a fluorine-based oil. Examples of the fluorine-based oil include perfluorocarbon (PFC), perfluoropolyether (PFPE), and hydrofluoroether (HFE). Examples of the perfluorocarbon include Fluorinert (trademark) FC40 and Fluorinert FC-770 (manufactured by 3M Company). Examples of the perfluoropolyether include Krytox (manufactured by DuPont). Examples of the hydrofluoroether include HFE7500 (manufactured by 3M Company).

The density of the hydrophobic liquid at 25° C. can be, for example, preferably 0.5 g/cm³ to 5 g/cm³, more preferably 0.6 g/cm³ to 4 g/cm³, and still more preferably 0.7 g/cm³ to 3 g/cm³.

The kinematic viscosity of the hydrophobic liquid at 25° C. can be, for example, preferably 0.3 cSt to 5 cSt, more preferably 0.4 cSt to 4 cSt, and still more preferably 0.5 cSt to 3 cSt.

The hydrophobic liquid has the above physical properties, whereby an emulsion is easily formed in the collection flow path. For example, in a case where the density or the kinematic viscosity is too high, a possibility increases that the liquid does not flow smoothly in the connection flow path.

In a preferred implementation of the present technology, one or both of the first liquid and the second liquid can contain a surfactant. Particularly, one or both of the hydrophobic liquid and the hydrophilic liquid contain a surfactant, more particularly the hydrophobic liquid contains a surfactant. By the surfactant, an emulsion particle is easily formed, and the emulsion particle can be stably maintained. Examples of the surfactant include a nonionic surfactant and a fluorine-based surfactant. Examples of the nonionic surfactant include, but are not limited to, Span80 and Abil EM. A type of the surfactant may be appropriately selected by one skilled in the art. Examples of the fluorine-based surfactant include a perfluoropolyether-based surfactant and a pseudosurfactant. Examples of the former include Krytox (manufactured by DuPont), and examples of the latter include perfluorooctanol.

The surfactant can be present, for example, in the hydrophobic liquid at or above a critical micelle concentration of the surfactant. The critical micelle concentration can be, for example, preferably 1 μM to 1000 μM, particularly 10 μM to 100 mM. The interfacial tension of the surfactant is, for example, preferably 40 mN/m or less, and may be particularly 20 mN/m or less.

In another implementation of the present technology, the first liquid may be a hydrophobic liquid, and the second liquid may be a hydrophilic liquid.

In this implementation, an emulsion containing the hydrophilic liquid as a dispersion medium and the hydrophobic liquid as a dispersoid can be formed in the collection flow path. The present technology may be used for sorting a microparticle in the emulsion. Examples of the hydrophobic liquid and the hydrophilic liquid are as described above.

Furthermore, this implementation can be applied to, for example, a case where only the sorting-target microparticle is further sorted from an emulsion in which the dispersion medium and the dispersoid are the hydrophobic liquid and the hydrophilic liquid, respectively, and an emulsion particle includes the microparticle.

Furthermore, as an assay system that can be used in the present technology, it is possible to use not only a system in which a microparticle emits fluorescence but also a system in which an emulsion particle emits fluorescence. For that reason, in order to collect the emulsion particle including the microparticle, the determination unit may make a determination on the microparticle, may make a determination on the emulsion particle, or may make a determination on both the microparticle and the emulsion particle. As described above, in the present technology, whether the microparticle or the emulsion particle is a sorting target may be determined on the basis of information obtained from the microparticle and/or the emulsion particle.

The microparticle sorting microchip used in the microparticle sorting device according to the present technology can be manufactured by a method known in the technical field. For example, it can be manufactured by bonding two substrates on which the flow paths as described in 1. described above are formed. The flow paths may be formed on both of the two substrates, or may be formed on only one of the substrates. In order to make adjustment of a position at the time of bonding the substrates easier, the flow path can be formed on only one substrate.

As a material for forming the microparticle sorting microchip used in the microparticle sorting device according to the present technology, a material known in the technical field can be used. Examples include, but are not limited to, for example, polycarbonate, cycloolefin polymer, polypropylene, polydimethylsiloxane (PDMS), polymethylmethacrylate (PMMA), polyethylene, polystyrene, glass, and silicon. Especially, polymer materials such as polycarbonate, cycloolefin polymer, polypropylene are particularly preferable because they are excellent in processability and may manufacture microchips inexpensively using a molding device.

The microparticle sorting device according to the present technology includes the control unit 103 that controls a sorting condition in the particle sorting section 157 on the basis of information on light detected by the emulsion detection unit 108. As illustrated in FIG. 4, the control unit 103 may include the signal processing unit 104 to which signals are transmitted, the signals being obtained by converting detected light into an analog electric signal or a digital electric signal by the particle detection unit 102 and/or the emulsion detection unit 108. The sorting control unit 106 may be provided that controls the actuator in a case where the electric signal processed is transmitted from the signal processing unit 104 to the determination unit 105 and the determination unit 105 determines that the microparticle is the sorting-target microparticle in the particle detection unit 102. The sorting control unit 106 can control the suction force by a piezoelectric drive voltage and a piezoelectric drive waveform in the actuator. Furthermore, as the information on the light from the emulsion detection unit 108, information regarding the presence or absence of the emulsion is obtained by forward-scattered light detection, and information regarding the presence or absence of the sorting-target microparticle in the emulsion is obtained by fluorescence detection, side-scattered light detection, and back-scattered light detection. Moreover, the control unit 103 can also adjust, as the sorting condition, the sorting delay time that is the time from the detection of the microparticle in the particle detection unit 102 to the suction of the microparticle in the particle sorting section 157, or the suction force that is the strength of suction in the particle sorting section.

The control unit 103 can change the sorting delay time from microparticle detection to suction operation, detect any one of fluorescence, side-scattered light, and back-scattered light, count the number of microparticles in the emulsion detected by the emulsion detection unit 108, and determine the sorting delay time in which the counted number becomes a predetermined value as an optimal sorting delay time. A maximum value of the counted number of the microparticles in the emulsion may be set as the predetermined value.

The control unit 103 can change the suction force, calculate the signal intensity of the forward-scattered light detected by the emulsion detection unit 108, and determine the suction force having a predetermined signal intensity as an optimal suction force. The signal intensity may be an area signal, a peak signal, or a width signal.

The control unit 103 can change the suction force, count the number of the emulsions detected by the emulsion detection unit 108, and determine the suction force with which the counted number of the emulsions becomes a predetermined value as the optimal suction force. The suction force can be determined by the piezoelectric drive waveform, the piezoelectric drive voltage, a sample liquid flow rate, a sheath liquid flow rate, a flow rate in the liquid supply flow path, and a flow rate (back pressure) in the collection flow path.

The control unit 103 can determine the optimal suction force on the basis of both the signal intensity of the forward-scattered light detected by the emulsion detection unit 108 and the counted number of the emulsions.

The microparticle sorting device according to the present technology may further include an information processing unit (not illustrated) that integrates information regarding the microparticle detected by the particle detection unit 102 and information regarding the microparticle in the emulsion detected by the emulsion detection unit 108 in order to confirm whether the sorting-target microparticle has been sorted.

### 2. Second Embodiment (Microparticle Sorting Method in Microparticle Sorting Device)

A microparticle sorting method in the microparticle sorting device according to the present technology includes a number-of-particles counting step, a step of repeating the number-of-particles counting step, and a step of determining a time (sorting delay time) at which suction should be performed. The microparticle sorting method in the microparticle sorting device according to the present technology will be described below with reference to FIG. 10. FIG. 10 illustrates a flowchart of the microparticle sorting method according to an embodiment of the present technology.

### (1) Number-of-Particles Counting Step S1001

In the number-of-particles counting step S1001 of FIG. 10, under a condition that suction by the collection flow path is performed with a predetermined suction force D₀ at a time point when a predetermined time T₀ elapses from when a microparticle passes through a predetermined position on the main flow path, a microparticle sorting procedure is executed in the microchip, and as a result of executing the sorting procedure, the number of sorting-target microparticles is counted that have passed through an emulsion detection region in the collection flow path. Note that the time T₀ may be the sorting delay time that is a time from detection of the microparticle in the particle detection unit to suction of the microparticle in the particle sorting section.

In the number-of-particles counting step S1001, a time point when the microparticle passes through can be detected at a predetermined position on the main flow path through which the first liquid containing the sorting-target microparticle flows. It is sufficient that the predetermined position on the main flow path is a position where the passage of the microparticle can be detected. The predetermined position can be, for example, in a particle detection region on the main flow path, and can be, for example, a light irradiation position by the first light irradiation unit.

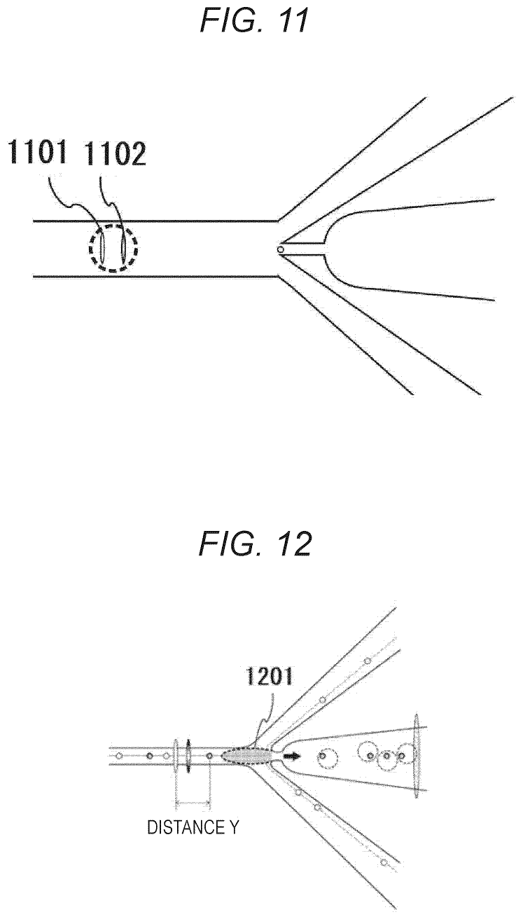

The predetermined position on the main flow path will be described with reference to FIG. 11. FIG. 11 is a diagram illustrating a position where passage of the microparticle is detected. As illustrated in FIG. 11, in the particle detection region, for example, two light beams 1101 and 1102 can be emitted perpendicularly to a traveling direction of the microparticle. An irradiation interval between the two light beams 1101 and 1102 can be, for example, 20 to 1000 μm, and more preferably 100 to 500 μm. Wavelengths of these two light beams may be different from each other or may be the same as each other. The predetermined position may be, for example, an irradiation position with the light beam 1102 on the collection flow path side of the two light beams, or may be an irradiation position with the other light beam 1101. When the microparticle passes through a portion to which the light beam is emitted, scattered light and/or fluorescence is generated, whereby the passage of the microparticle can be detected.

In the number-of-particles counting step S1001, the sorting-target microparticle is sucked into the collection flow path from the main flow path with a predetermined suction force by the collection flow path. The suction can be performed when the predetermined time T₀ elapses after the passage through the predetermined position. The predetermined time T₀ after the passage through the predetermined position may be appropriately set by one skilled in the art, and can be determined in consideration of, for example, a size of the microchip, particularly a distance from the light irradiation region on the main flow path of the microchip to an entrance of the connection flow path and/or a flow speed of the microparticle. The distance can be, for example, a distance from the irradiation position with a light beam on the collection flow path side of the two light beams to the entrance of the connection flow path. The distance can be, for example, preferably 10 μm to 5000 μm, and more preferably 100 μm to 3000 μm.

For example, the time T₀ can be a time from a time point of passage through the predetermined position to a time point when the sorting-target microparticle reaches any position in a region where the sorting-target microparticle is sucked into the collection flow path in a case where suction is performed with the suction force D₀. Alternatively, this may also be a time from the time point of the passage through the predetermined position to a time point before the arrival to the region.

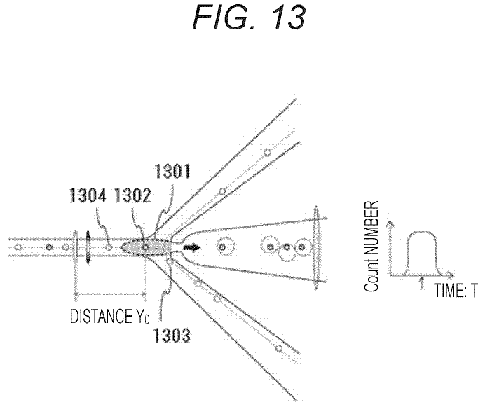

The time T₀ will be further described with reference to FIG. 12. FIG. 12 is a diagram illustrating a region where the sorting-target microparticle is sucked into the collection flow path in a case where suction is performed under a predetermined condition. In FIG. 12, a region 1201 expanding in an elliptical shape from an entrance of the collection flow path toward the irradiation region is a region where the microparticle is sucked into the collection flow path in a case where suction is performed with the suction force D₀. In FIG. 12, there is the microparticle at a position advanced by a distance Y from the light irradiation position. The microparticle has not yet reached the inside of the region 1201. A time from a time point of passage through the light irradiation position to a time point when the microparticle travels the distance Y may be adopted as the time T₀. Alternatively, when time further elapses, the microparticle reaches the inside of the region 1201. A time from the time point of passage through the light irradiation position to a time point when the microparticle reaches any position in the region 1201 may be adopted as the time T₀.

In setting of the time T₀, a speed in the flow path of the microparticle can be taken into consideration, as necessary. The speed may be appropriately measured by a method known to one skilled in the art. For example, as illustrated in FIG. 11 described above, in a case where the two light irradiation positions 1101 and 1102 are provided, the speed in the flow path of the microparticle can be calculated on the basis of a distance between the two irradiation positions and a time required for passage between the two irradiation positions. By such a calculation method, the speed of the microparticle can be calculated more accurately. Furthermore, the speed of the microparticle is calculated more accurately, whereby optimization of a suction condition can be better performed.

Furthermore, a distance from the predetermined position can be calculated from the speed and an elapsed time. In another implementation of the present technology, instead of time T, the distance Y from the predetermined position may be used as a variable. That is, in another implementation of the present technology, in the number-of-particles counting step, under a condition that suction by the collection flow path is performed with the predetermined suction force D₀ when the microparticle travels toward the collection flow path by a predetermined distance Y₀ from a predetermined position on the main flow path, the microparticle sorting procedure is executed in the microchip, and as a result of executing the sorting procedure, the number of microparticles can be counted that have passed through the emulsion detection region in the collection flow path. In this implementation, the distance from the predetermined position is determined, at which the suction by the collection flow path should be performed. That is, in the present technology, instead of a timing at which the suction should be performed, the distance from the predetermined position can be optimized, at which the suction should be performed. The optimization of the distance may also be performed in following third and fourth embodiments. That is, in the third and fourth embodiments, instead of the time T, the distance Y from the predetermined position may be used as the variable.

The suction by the collection flow path with the predetermined suction force D₀ can be performed, for example, by making the inside of the collection flow path a negative pressure. Making the negative pressure can be performed by, for example, a piezoelectric element. Since there is a predetermined relationship between the suction force D₀ and the drive voltage of the piezoelectric element, the suction force D₀ can be adjusted by adjustment of the drive voltage of the piezoelectric element. The adjustment of the drive voltage of the piezoelectric element may be performed by means known to one skilled in the art. Furthermore, since there is a predetermined relationship between the suction force D₀ and the drive waveform (rise time/hold time/fall time) of the piezoelectric element, the suction force D₀ can be adjusted by adjustment of the drive waveform of the piezoelectric element. Moreover, since there is a predetermined relationship between the suction force D₀, and the sample liquid flow rate, the sheath liquid flow rate, the flow rate in the liquid supply flow path, and the flow rate (back pressure) in the collection flow path, the suction force D₀ can be adjusted by adjustment of these flow rates.

In the number-of-particles counting step S1001, the microparticle sorting procedure can be executed, for example, by using a microparticle sorting device equipped with the microchip described in 1. described above. In the microparticle sorting procedure, the sample liquid can be used containing a known number of sorting-target microparticles. The number of sorting-target microparticles can be appropriately set by one skilled in the art, and can be, for example, 10 to 1000, particularly 30 to 500, and more particularly 50 to 300. In the microparticle sorting procedure, the sample liquid containing the known number of the microparticles is introduced from the sample liquid inlet 151, then, travels through the sample liquid flow path 152, and the sheath liquid is introduced from the sheath liquid inlet 153, then, travels through the sheath liquid flow path 154. The sample liquid and the sheath liquid merge to form a laminar flow, then, the laminar flow flows through the main flow path 155 toward the particle sorting section 157. Light is emitted to the laminar flow in the particle detection region 156. The sorting-target microparticle passes through the particle detection region 156, whereby scattered light and/or fluorescence is generated from the microparticle. Only in a case where the scattered light and/or the fluorescence is detected, the suction with the suction force D₀ is performed at the time point when the predetermined time T₀ elapses from when the microparticle passes through the predetermined position. For example, in the microparticle sorting procedure using the sample liquid containing 100 sorting-target microparticles, suction is performed for each microparticle, that is, suction can be performed 100 times.

In the number-of-particles counting step S1001, the number of sorting-target microparticles is counted that have passed through the emulsion detection region in the collection flow path. For example, in the number-of-particles counting step S1001, as a result of performing the microparticle sorting procedure on the known number of the microparticles, the number of sorting-target microparticles is counted that have passed through the emulsion detection region in the collection flow path. For example, the number of sorting-target microparticles can be counted by detection of passage through the emulsion detection region in the collection flow path. An example of the emulsion detection region provided in the collection flow path is the emulsion detection region 164 illustrated in FIG. 5, for example. As illustrated in FIG. 5, the microparticle passes through the emulsion detection region 164 provided in the collection flow path 159, whereby scattered light and/or fluorescence is emitted from the microparticle. The scattered light and/or fluorescence is detected, whereby the number of sorting-target microparticles sucked into the collection flow path 159 can be counted.

In the present technology, the microparticle may be appropriately selected by one skilled in the art. In the present technology, microparticles can include biological microparticles such as cells, microorganisms, and liposomes, synthetic particles such as latex particles, gel particles, and industrial particles, and the like. In the method of the present technology, the synthetic particles may be preferably used and beads for optimizing the suction condition may be particularly preferably used as the microparticles. The synthetic particles can be more easily available than the biological microparticles, so that they are more preferred for the method of the present technology.

The biological microparticles can include chromosomes, liposomes, mitochondria, organelles (cell organelles) and the like constituting various cells. The cells can include animal cells (such as blood cells) and plant cells. The microorganisms can include bacteria such as Escherichia coli, viruses such as tobacco mosaic virus, fungi such as yeast, and the like. Moreover, the biological microparticles can also include biological polymers such as nucleic acids, proteins, and complexes thereof. Furthermore, the synthetic particles can be particles including, for example, organic or inorganic polymer materials, metal, or the like. The organic polymer materials can include polystyrene, styrene/divinylbenzene, polymethyl methacrylate, and the like. The inorganic polymer materials may include glass, silica, a magnetic material and the like. The metal can include gold colloid, aluminum, and the like. A shape of the microparticle may be spherical or substantial spherical or non-spherical in general. A size and mass of the microparticle may be appropriately selected by one skilled in the art depending on a size of the flow path of the microchip. The size of the flow path of the microchip may be appropriately selected depending on the size and mass of the microparticle. In the present technology, chemical or biological labels, for example, fluorescent dyes and the like, can be attached to the microparticles, as necessary. The label can make detection of the microparticles easier. The label that should be attached can be appropriately selected by one skilled in the art.

### (2) Step S1002 of Repeating Number-of-Particles Counting Step

In a repeating step S1002 of FIG. 10, the number-of-particles counting step is repeated while changing a time from a time point when the sorting-target microparticle passes through the predetermined position of the main flow path to when the suction is performed. For example, the number-of-particles counting step is repeated in the same manner except that the T₀ is changed to various longer and/or shorter times Tₙ. The time Tₙ can be appropriately set by one skilled in the art in consideration of, for example, the size of the microchip, a region covered by a predetermined suction force in a case where the suction force is applied, and/or tolerance. The number-of-particles counting step is repeated for each of the various times Tₙ in the repeating step S1002, whereby a number-of-particles counting result is obtained for each of the various times Tₙ.

For example, the various times Tₙ can be times obtained by increasing and/or decreasing the T₀ stepwise at a predetermined rate. The predetermined rate can be, for example, 0.01% to 5%, particularly 0.05 to 2%, and more particularly 0.1 to 1%. The number of steps of increasing and/or decreasing the T₀ can be, for example, 5 to 50 steps, particularly 7 to 40 steps, and more particularly 10 to 30 steps. For example, in a case where the various times Tₙ are the times obtained by increasing and decreasing the T₀ in 20 steps by 0.2%, the various times Tₙ are (T₀+T₀×0.2%), (T₀+T₀×0.2%×2), (T₀+T₀×0.2%×3), . . . , and (T₀+T₀×0.2%×20), and (T₀−T₀×0.2%), (T₀−T₀×0.2%×2), (T₀−T₀×0.2%×3), . . . , and (T₀−T₀×0.2%×20). In this case, the microparticle sorting procedure can be performed in each of a total of 41 (1+20+20) elapsed times, including the T₀.

Furthermore, the number of steps of increasing the T₀ and the number of steps of decreasing the T₀ may be the same as each other or different from each other. Furthermore, the various times Tₙ may be obtained only by increasing the T₀, or may be obtained only by decreasing the T₀. The number of steps of increasing the T₀ and the number of steps of decreasing the T₀ can be set appropriately by one skilled in the art. Furthermore, for each of the various times Tₙ, the number-of-particles counting step may be performed a plurality of times, for example, 2 to 5 times, particularly 2 to 3 times.

The number-of-particles counting step performed in the repeating step S1002 is the same except that the T₀ is changed to the various longer and/or shorter times Tₙ. For that reason, as for the description regarding the number-of-particles counting step, please refer to (1) described above.

### (3) Step S1003 of Determining Time at Which Suction Should be Performed

In step S1003 of determining a time at which suction should be performed in FIG. 10, an elapsed time from the passage through the predetermined position, with which the suction by the collection flow path should be performed, is determined on the basis of the number of sorting-target microparticles counted in the number-of-particles counting step S1001 or in the number-of-particles counting step S1001 and the repeating step S1002. As a result, a time point when the suction of the microparticle should be performed is optimized. Furthermore, the determination can be automatically performed by a control unit incorporating a predetermined program, and the like. Note that the optimized time may be an optimal sorting delay time that is a time from detection of the microparticle in the particle detection unit to suction of the microparticle in the particle sorting section.

In step S1003 of determining the time at which the suction should be performed, for example, the time T in a case where the number of microparticles counted in the number-of-particles counting step S1001 and the repeating step S1002 is the largest can be determined as the elapsed time with which the suction should be performed. Alternatively, in a case where there is a plurality of times of a case where the number of microparticles is the largest, any time out of the plurality of times may be determined as the elapsed time with which the suction should be performed, or a central value out of the plurality of times may be determined as the elapsed time with which the suction should be performed.

The elapsed time with which the suction should be performed will be hereinafter described in more detail with reference to FIG. 13.

FIG. 13 is a schematic diagram illustrating a situation in the flow path in a case where the microparticle sorting procedure is performed under a condition that suction by the collection flow path is performed with the predetermined suction force D₀ at a time point when the predetermined time T₀ elapses from when the sorting-target microparticle passes through a predetermined position on the main flow path. In FIG. 13, a region 1301 expanding in an elliptical shape from the entrance of the collection flow path toward the irradiation region is a region where the sorting-target microparticle is sucked into the collection flow path in a case where suction is performed with the suction force D₀. In FIG. 13, the predetermined position is a position farther from the collection flow path among two light irradiation positions. A microparticle 1302 that has passed through the predetermined position travels the distance Y₀ from the predetermined position due to a lapse of the predetermined time T₀ and is present in a position as illustrated in FIG. 13. In a case where suction by the collection flow path is performed with the predetermined suction force D₀ at a time point when the predetermined time T₀ has elapsed from the passage through the predetermined position, the microparticle 1302 is present in the region 1301, and thus is sucked into the collection flow path.

Note that, as illustrated in FIG. 13, at the time point when the predetermined time T₀ has elapsed after passage of the microparticle through the predetermined position, the microparticle is theoretically present in the region 1301. However, due to factors such as, for example, a situation of the formed laminar flow, a shape of the particle, and/or an actual suction force, there also is a case where suction into the collection flow path is not performed.

In FIG. 13, in a case where suction is performed at Tᵢ obtained by increasing the time T₀, the microparticle is present at, for example, a position 1303. Even if suction is performed with the suction force D₀ in a case where the microparticle is present at the position 1303, the microparticle is present outside the region 1301 and thus is not sucked into the collection flow path.

Furthermore, in FIG. 13, in a case where suction is performed at Tⱼ obtained by decreasing the time T₀, the microparticle is present at, for example, a position 1304. Even if suction is performed with the suction force D₀ in a case where the microparticle is present at the position 1304, the microparticle is present outside the region 1301 and thus is not sucked into the collection flow path.

Note that, as illustrated in FIG. 13, at a time point when the time Tᵢ or Tⱼ has elapsed after passage of the microparticle through the predetermined position, the microparticle is theoretically present outside the region 1301. However, due to the factors such as, for example, the situation of the formed laminar flow, the shape of the particle, and/or the actual suction force, there also is a case where suction into the collection flow path is performed.

On the right side of FIG. 13, a graph is illustrated in which the T₀ is changed to various times and the number of particles counted at each time is plotted against the time. As illustrated in the graph, the number of microparticles counted is the largest in a case where the elapsed time is within a predetermined range. Any time within the predetermined range may be determined as the elapsed time with which the suction should be performed, or a central value within the predetermined range may be determined as the elapsed time with which the suction should be performed.

According to one implementation of the present technology, in the step of determining, a success rate of suction of the sorting-target microparticle into the collection flow path can be calculated on the basis of the number of sorting-target microparticles counted in the number-of-particles counting step and the repeating step, and on the basis of the success rate, an elapsed time from the passage through the predetermined position, with which the suction by the collection flow path should be performed, can be determined. For example, the elapsed time in a case where the success rate is the highest may be determined as the elapsed time from the passage through the predetermined position, with which the suction by the collection flow path should be performed. Alternatively, any time may be determined as the elapsed time with which the suction should be performed among a plurality of elapsed times for which the success rate is a predetermined value or larger, or a central value among the plurality of elapsed times may be determined as the elapsed time with which the suction should be performed.

According to the present technology, the sorting (suction) condition for the sorting-target microparticle is optimized. Furthermore, since the method of the present technology can be performed automatically, optimization of the sorting (suction) condition for the microparticle can be performed automatically. As a result, man-hours of a worker who performs microparticle sorting and the time required for the sorting condition can be reduced.

Furthermore, in the method of the present technology, the steps of the elapsed time increased and/or decreased in the repeating step are adjusted, whereby the optimization of the sorting (suction) condition for the microparticle can be performed more accurately.

The sorting (suction) condition for the sorting-target microparticle is optimized by the method of the present technology, whereby sorting of a sample, for example, a biological sample, in the microparticle sorting device can be performed more quickly and more efficiently. For example, purity or density of a sorted biological sample can be improved.

Moreover, with the method of the present technology, an expensive observation system can be unnecessary such as a high-speed camera conventionally used for optimization of the suction condition for the microparticle, and it is possible to enable downsizing of the microparticle sorting device and/or reduction of manufacturing cost.

Note that these effects can also be exerted by following third, fourth, fifth, and sixth embodiments.

### 3. Third Embodiment (Microparticle Sorting Method in Microparticle Sorting Device)

A microparticle sorting method in the microparticle sorting device according to the present technology can further include a second repeating step of changing the suction force and repeating the number-of-particles counting step and/or the repeating step. In a case where the optimizing method of the present technology includes the second repeating step, in the step of determining, an elapsed time from when the microparticle passes through the predetermined position, with which the suction by the microparticle suction flow path should be performed, and/or a suction force that should be applied to the suction of the microparticle can be determined on the basis of the number of microparticles counted in the number-of-particles counting step and/or the repeating step and the second repeating step.

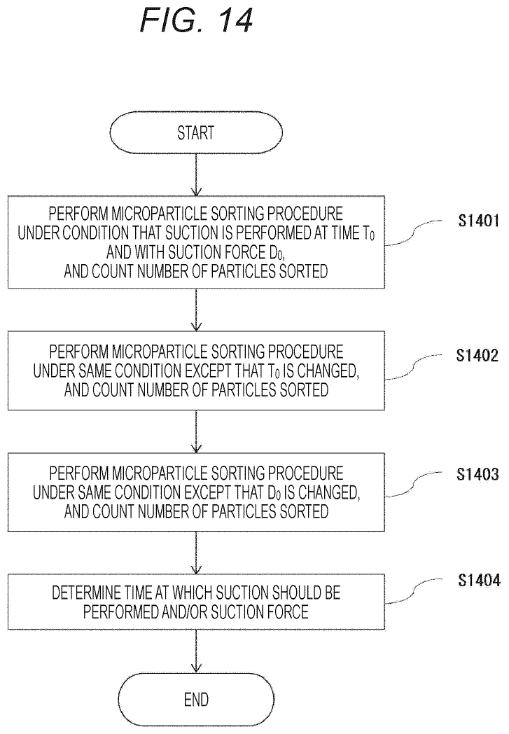

FIG. 14 illustrates an example of a flowchart in a case where the optimizing method of the present technology includes the second repeating step. In FIG. 14, steps S1401 and S1402 are the same as steps S1001 and S1002 described in 2. described above. For that reason, the description of these steps is omitted.

### (1) Second Repeating Step S1403 of Repeating Number-of-Particles Counting Step

In a second repeating step S1403 in FIG. 14, the number-of-particles counting step and/or the repeating step can be repeated in the same manner except that the suction force D₀ is changed to various larger and/or smaller suction forces Dₙ. Preferably, in the second repeating step S1403 in FIG. 14, the number-of-particles counting step S1401 and the repeating step S1402 can be repeated in the same manner except that the suction force D₀ is changed to various smaller suction forces Dₙ. The suction forces Dₙ can be appropriately set by one skilled in the art in consideration of factors such as, for example, a specification of a suction means provided on the collection flow path, the size of the microchip, a region covered by a predetermined suction force in a case where the suction force is applied, and/or tolerance. The number-of-particles counting step is performed for each of the various suction forces Dₙ in the repeating step S1403, whereby a number-of-particles counting result is obtained for each of the various suction forces Dₙ.

For example, the various suction forces Dₙ can be suction forces obtained by increasing or decreasing the D₀ stepwise at a predetermined rate. The predetermined rate can be, for example, 0.01 to 30%, particularly 0.1% to 25%, more particularly 1 to 20%, and still more particularly 1 to 10%. The number of steps for increasing or decreasing the D₀ can be, for example, 3 to 20 steps, particularly 4 to 15 steps, and more particularly 5 to 10 steps. For example, in a case where the various suction forces Dₙ are obtained by decreasing the D₀ by four steps by 20%, the various suction forces Dₙ are (D₀−D₀×20%), (D₀−D₀×20%×2), (D₀−D₀×20%×3), and (D₀−D₀×20%×4). In this case, a microparticle sorting procedure can be performed in each of a total of five suction forces including the D₀.

Furthermore, the number of steps of increasing the D₀ and the number of steps of decreasing the D₀ may be the same as each other or different from each other. Furthermore, the various suction forces Dₙ may be obtained only by increasing the D₀, or may be obtained only by decreasing the D₀. The number of steps of increasing the D₀ and the number of steps of decreasing the D₀ can be appropriately set according to a value of the D₀. Furthermore, for each of the various suction forces Dₙ, the number-of-particles counting step may be performed a plurality of times, for example, two to five times, particularly two to three times.

The number-of-particles counting step performed in the second repeating step S1403 is the same as the steps S1001 and S1002 described in 2. described above except that the D₀ is changed to a smaller suction force or a larger suction force Dₙ. For that reason, for the description of the number-of-particles counting step, please refer to (1) and (2) in 2. described above.

### (2) Step S1404 of Determining Time at Which Suction Should be Performed and/or Suction Force that Should be Applied

In step S1404 of determining the time in which the suction should be performed and/or the suction force that should be applied in FIG. 14, the elapsed time from the passage through the predetermined position, with which the suction by the collection flow path should be performed, and/or the suction force that should be applied to the suction of the microparticle is determined on the basis of the number of microparticles counted in the number-of-particles counting step S1401, the repeating step S1402, and the second repeating step S1403. As a result, the time point when the suction of the microparticle should be performed and the suction force that should be applied are optimized. Note that the optimized time may be an optimal sorting delay time that is a time from detection of the microparticle in the particle detection unit to suction of the microparticle in the particle sorting section. Furthermore, the determination can be automatically performed by, for example, a control unit incorporating a predetermined program, and the like.

In step S1404 of determining, for example, a time T and a suction force D in a case where the number of microparticles counted in the number-of-particles counting step S1401, the repeating step S1402, and the second repeating step S1403 is the largest and the suction force is the smallest can be determined as the elapsed time with which the suction should be performed and the suction force that should be applied.

Alternatively, the suction force D that is the smallest suction force may be determined as the suction force that should be applied from combinations of the time Tₙ and the suction force Dₙ in a case where a predetermined number or more of microparticles are counted, and a central value among a plurality of elapsed times with which the predetermined number or more of the microparticles are counted at the determined suction force may be determined as the elapsed time with which the suction should be performed.

Alternatively, in a case where there are two or more combinations of time and suction force with which the predetermined number or more of the microparticles are counted and the suction force is the smallest, any combination of time and suction force from the combinations may be determined as the elapsed time with which the suction should be performed and the suction force that should be applied. Alternatively, in a case where there are two or more combinations of time and suction force with which the predetermined number or more of the microparticles are counted and the suction force is the smallest, the smallest value of the suction force may be determined as the suction force that should be applied, and a central value of the plurality of times may be determined as the elapsed time with which the suction should be performed.

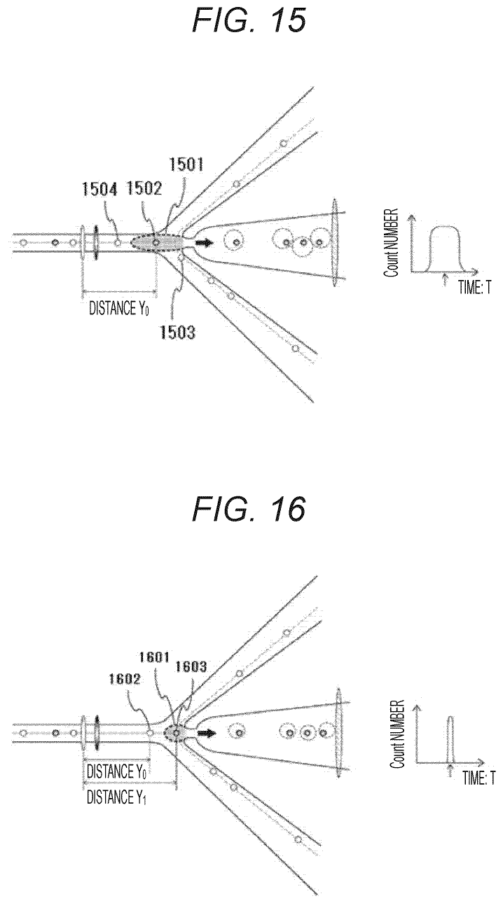

The elapsed time with which the suction should be performed and the suction force that should be applied will be hereinafter described in further detail with reference to FIGS. 15 and 16.

FIG. 15 is a schematic diagram illustrating a situation in the flow path in a case where the microparticle sorting procedure is performed as described above. As described above, in a case where the suction by the collection flow path is performed with the predetermined suction force D₀ at the time point when the predetermined time T₀ has elapsed from the passage through the predetermined position, a microparticle 1502 is present in a region 1501, and thus is sucked into the collection flow path.

FIG. 16 is a schematic diagram illustrating a situation in the flow path in a case where the microparticle sorting procedure is performed under a condition that the suction by the collection flow path is performed with the suction force Dₙ smaller than the suction force D₀ at a time point when the predetermined time T₀ or T₁ elapses from when the microparticle passes through the predetermined position on the main flow path. In FIG. 16, a region 1601 expanding in an elliptical shape from the entrance of the collection flow path toward the irradiation region is a region where the microparticle is sucked into the collection flow path in a case where suction is performed with the suction force Dₙ. In FIG. 16, the predetermined position is a position farther from the collection flow path among two light irradiation positions.

A microparticle 1602 that has passed through the predetermined position travels the distance Y₀ from the predetermined position due to a lapse of the predetermined time T₀ and is present in a position as illustrated in FIG. 16. In a case where suction is performed with the suction force D₀ as illustrated in FIG. 15 at a time point when the microparticle 1602 is present in this position, the microparticle 1602 is present in the region 1601, and thus is sucked into the collection flow path. However, in a case where the suction is performed with the suction force Dₙ as illustrated in FIG. 16 at the time point when the microparticle 1602 is present in this position, the microparticle 1602 is present outside the region 1601, and thus is not sucked into the collection flow path.

Furthermore, a microparticle 1603 that has passed through the predetermined position travels a distance Y₁ from the predetermined position due to a lapse of the predetermined time T₁ and is present in a position as illustrated in FIG. 16. In a case where suction by the collection flow path is performed with the predetermined suction force Dₙ at a time point when the predetermined time T₁ has elapsed from the passage through the predetermined position, the microparticle 1603 is present in the region 1601, and thus is sucked into the collection flow path.

As described above, the smaller the suction force, the narrower the region covered by the suction force.

On the right side of FIG. 16, a graph is illustrated in which the T₀ is changed to various times and the number of microparticles counted at each time is plotted against the time. As illustrated in the graph, a range of the time T in which the counted number is high is narrower than a range in the graph illustrated on the right side of FIG. 16. As described above, the smaller the suction force, the narrower the range of the time T in which the counted number is high. The elapsed time is adopted in which the suction should be performed from a more narrowed range of the time T and a smaller suction force is adopted as the suction force that should be applied, whereby the elapsed time with which the suction of the microparticle should be performed and the suction force that should be applied can be optimized.

According to one implementation of the present technology, in the step of determining, a success rate of the suction into the collection flow path of the microparticle is calculated on the basis of the number of microparticles counted in the number-of-particles counting step, the repeating step, and the second repeating step, and on the basis of the success rate, the elapsed time from the passage through the predetermined position, with which the suction by the collection flow path should be performed, and/or the suction force that should be applied can be determined.

For example, the time T and the suction force D in a case where the success rate is the highest and the suction force is the smallest can be determined as the elapsed time with which the suction should be performed and the suction force that should be applied.

Alternatively, from combinations of the time Tₙ and the suction force Dₙ in a case of a success rate greater than or equal to a predetermined rate, the time T and the suction force D with which the suction force is the smallest may be determined as the elapsed time with which the suction should be performed and the suction force that should be applied.

Alternatively, in a case where there are two or more combinations of the time and suction force with which the success rate greater than or equal to the predetermined rate is achieved and the suction force is the smallest, from the combinations, any combination of the time and suction force may be determined as the elapsed time with which the suction should be performed and the suction force that should be applied. Alternatively, in a case where there are two or more combinations of the time and suction force with which the success rate greater than or equal to the predetermined rate is achieved and the suction force is the smallest, the smallest suction force may be determined as the suction force that should be applied and a central value of the plurality of times may be determined as the elapsed time with which the suction should be performed.

### (3) Preferred Implementation of Second Repeating Step S1403

According to a preferred implementation, in the second repeating step S1403, the suction force can be decreased stepwise at a predetermined rate from the suction force D₀, and the second repeating step can be performed until a result is obtained in which the number of microparticles sucked into the collection flow path is 0 in any case of elapsed time. In this case, in the step of determining, a suction force obtained by increasing, at a predetermined rate, a suction force in a case where the result is obtained in which the number is 0 in any case of elapsed time can be determined as the suction force that should be applied to the suction of the microparticle. As a result, the optimization of the suction force can be performed automatically.

A change in situation in the flow path in a case where the suction force is decreased from the suction force D₀ is as described above with reference to FIGS. 15 and 16. The predetermined rate and the number of steps for decreasing are as described in (1) described above.

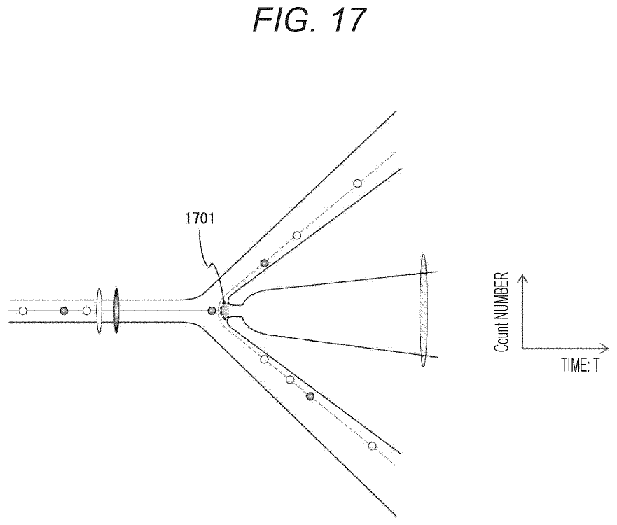

The situation in the flow path in a case where the result is obtained in which the number of microparticles sucked into the collection flow path is 0 in any case of elapsed time will be described below with reference to FIG. 17. In FIG. 17, a solid line and a dotted line in the flow path indicate positions through which the microparticle passes. In FIG. 17, a region 1701 slightly expanding from the entrance of the collection flow path toward the irradiation region is a region where the microparticle is sucked into the collection flow path in a case where suction is performed with a suction force D_{Z} smaller than a suction force D₁. As illustrated in FIG. 17, the region 1701 does not overlap with either the solid line or the dotted line indicating the positions through which the microparticle passes. For that reason, the microparticle is not sucked even if the suction is performed in any case of elapsed time. On the right side of FIG. 17, a graph is illustrated in which the T₀ is changed to various times and the number of microparticles counted at each time is plotted against the time. As illustrated in the graph, the counted number is 0 even if the suction is performed in any case of elapsed time.

In the preferred implementation described above, the second repeating step can be performed until the result is obtained in which the number of microparticles sucked into the collection flow path is 0 in any case of elapsed time. That is, the second repeating step can be finished in a case where the result is obtained in which the number of microparticles sucked into the collection flow path is 0 in any case of elapsed time. Then, in the step of determining, a suction force obtained by increasing, at a predetermined rate, a suction force in a case where the result is obtained in which the number is 0 in any case of elapsed time can be determined as the suction force that should be applied to the suction of the microparticle.

One skilled in the art can appropriately determine whether to determine, as the suction force that should be applied to the suction of the microparticle, a suction force obtained by increasing, to a certain extent, a suction force in a case where the result is obtained in which the number is 0 in any case of elapsed time, on the basis of factors such as the predetermined rate and the number of steps for decreasing suction force in the stepwise decrease in the suction force in the second repeating step S1403, the value of D₀ adopted in the step 1401, and/or the size of the flow path. For example, in a case of decreasing D₀ by 1 to 10% each time, from the suction force with which the result is obtained in which the number is 0 in any case of elapsed time, for example, a value obtained by adding a value from (the decreasing rate (that is, 1 to 10%)×1) to (the decreasing rate×5) to the suction force with which the result is obtained in which the number is 0 in any case of elapsed time can be determined as the suction force that should be applied. For example, in a case where D₀ is decreased by 10% each time and the result is obtained in which the number is 0 in any case of elapsed time at the suction force of D₀−D₀×80%, a value of (D₀−D₀×80%)+D₀×20%, that is, D₀−D₀×60% can be determined as the suction force that should be applied.

### 4. Fourth Embodiment (Microparticle Sorting Method in Microparticle Sorting Device)

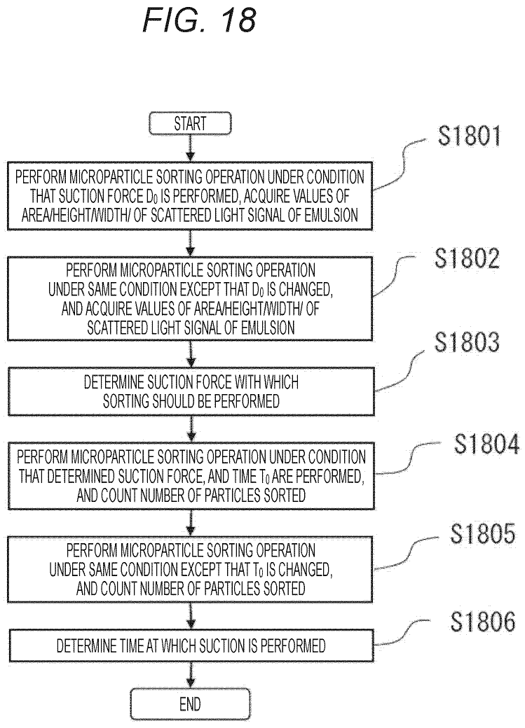

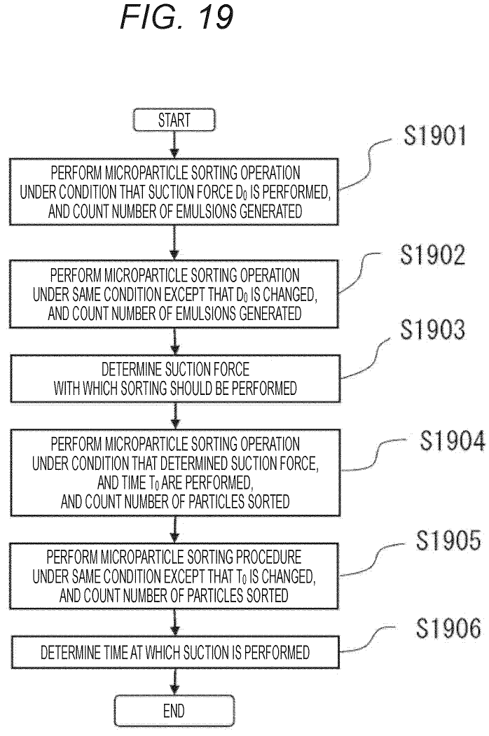

A microparticle sorting method in the microparticle sorting device according to the present technology includes: an emulsion detection step; a step of repeating the emulsion detection step; a suction force determination step; a number-of-particles counting step; a step of repeating the number-of-particles counting step; and a step of determining a time at which suction is performed. FIG. 18 illustrates an example of a flowchart of the microparticle sorting method of the present embodiment. In FIG. 18, steps S1804, S1805, and S1806 are the same as steps S1001, S1002, and S1003 described in 2. described above. For that reason, the description of these steps is omitted.

### (1) Emulsion Detection Step S1801

In an emulsion detection step S1801 in FIG. 18, under a condition that suction by the collection flow path is performed with the predetermined suction force D₀, a microparticle sorting procedure is executed in the microchip, and as a result of executing the sorting procedure, an emulsion is detected that has passed through an emulsion detection region in the collection flow path, and a value is acquired of a signal intensity (area signal, peak signal, width signal) of forward-scattered light.

In the emulsion detection step S1801, suction is performed with the predetermined suction force D₀, and the signal intensity (area signal, peak signal, width signal) is acquired of forward-scattered light of the emulsion that have passed through the emulsion detection region in the collection flow path. The acquisition can be performed in the emulsion detection region 164 provided in the collection flow path. As illustrated in FIG. 5, the emulsion passes through the emulsion detection region 164 provided in the collection flow path, whereby the forward-scattered light is emitted from the emulsion. The scattered light is detected, whereby the signal intensity (area signal, peak signal, width signal) can be acquired of the forward-scattered light of the emulsion sucked into the collection flow path. When the signal intensity is acquired, a known number of microparticle sorting operations may be performed to acquire the signal intensity (area signal, peak signal, width signal). The number of microparticle sorting operations may be appropriately set by one skilled in the art, and can be, for example, 10 to 1000, particularly 30 to 500, and more particularly 50 to 300. The suction is performed with the predetermined suction force D₀, and light is emitted to the emulsion sucked into the collection flow path in the emulsion detection region 164. The emulsion passes through the emulsion detection region 164, whereby the forward-scattered light is generated from the emulsion. The forward-scattered light is detected to acquire the signal intensity (area signal, peak signal, width signal) of the forward-scattered light. Note that in the emulsion detection step S1801, the microparticle does not have to flow from the sample flow path. For example, in the control unit, the emulsion detection step can be performed by generating a pseudo detection signal of the particle detection unit and performing suction operation.

### (2) Step S1802 of Repeating Emulsion Detection Step

In a repeating step S1802 of FIG. 18, the emulsion detection step can be repeated in the same manner except that the suction force D₀ is changed to various larger and/or smaller suction forces Dₙ. Preferably, in the repeating step S1802 of FIG. 18, the emulsion detection step S1801 can be repeated in the same manner except that the suction force D₀ is changed to various small suction forces Dₙ. The suction forces Dₙ can be appropriately set by one skilled in the art in consideration of factors such as, for example, a specification of a suction means provided on the collection flow path, the size of the microchip, a region covered by a predetermined suction force in a case where the suction force is applied, and/or tolerance. In the repeating step S1802, the emulsion detection step is performed for each of the various suction forces Dₙ, whereby the signal intensity (area signal, peak signal, width signal) of the forward-scattered light is obtained for each of the various suction forces Dₙ.

For example, the various suction forces Dₙ can be suction forces obtained by increasing or decreasing the D₀ stepwise at a predetermined rate. The predetermined rate can be, for example, 0.01 to 30%, particularly 0.1% to 25%, more particularly 1 to 20%, and still more particularly 1 to 10%. The number of steps for increasing or decreasing the D₀ can be, for example, 3 to 20 steps, particularly 4 to 15 steps, and more particularly 5 to 10 steps. For example, in a case where the various suction forces Dₙ are obtained by decreasing the D₀ by four steps by 20%, the various suction forces Dₙ are (D₀−D₀×20%), (D₀−D₀×20%×2), (D₀−D₀×20%×3), and (D₀−D₀×20%×4). In this case, the emulsion detection step can be performed in each of a total of five suction forces including the D₀.

Furthermore, the number of steps of increasing the D₀ and the number of steps of decreasing the D₀ may be the same as each other or different from each other. Furthermore, the various suction forces Dₙ may be obtained only by increasing the D₀, or may be obtained only by decreasing the D₀. The number of steps of increasing the D₀ and the number of steps of decreasing the D₀ can be appropriately set according to a value of the D₀. Furthermore, for each of the various suction forces Dₙ, the emulsion detection step may be performed a plurality of times, for example, two to five times, particularly two to three times.

### (3) Step S1803 of Determining Suction Force

In step S1803 of determining the suction force that should be applied in FIG. 18, from the signal intensity (area signal, peak signal, width signal) of the forward-scattered light obtained in the repeating step S1802, the suction force D in a case where the signal intensity is larger than a predetermined signal intensity (area signal, peak signal, width signal) and the suction force is the smallest can be determined as the suction force that should be applied. Alternatively, in a case where there is a plurality of the smallest suction forces Dₙ larger than the predetermined signal intensity (area signal, peak signal, width signal), any suction force D among them may be determined as the suction force that should be applied, or a central value among them may be determined as the suction force that should be applied.

Alternatively, the suction force D in a case where the signal intensity is closest to the predetermined signal intensity (area signal, peak signal, width signal) may be determined as the suction force that should be applied, or the suction force D in a case where variation in values of the signal intensity (area signal, peak signal, width signal) is the smallest may be determined as the suction force that should be applied. Furthermore, the determination can be automatically performed by, for example, a control unit incorporating a predetermined program, and the like.

Since the signal intensity of the forward-scattered light acquired in the emulsion detection step correlates with the volume of the first liquid in the second liquid, the suction force D can also be determined so that the signal intensity has a prescribed value determined in advance. By adopting this step, it is possible to generate emulsions of the first liquid whose volumes are the same or have a variation within a certain range even when using different microflow path chips and different microparticle sorting devices, and it is possible to standardize an emulsion generation step.

### 5. Fifth Embodiment (Microparticle Sorting Method in Microparticle Sorting Device)

A microparticle sorting method in the microparticle sorting device according to the present technology includes: an emulsion counting step; a step of repeating the emulsion counting step; a suction force determination step; a number-of-particles counting step; a step of repeating the number-of-particles counting step; and a step of determining a time at which suction is performed.

FIG. 19 illustrates an example of a flowchart of the microparticle sorting method of the present embodiment. In FIG. 19, steps S1904, S1905, and S1906 are the same as steps S1001, S1002, and S1003 described in 2. described above. For that reason, the description of these steps is omitted.

### (1) Emulsion Counting Step S1901

In an emulsion counting step S1901 of FIG. 19, under a condition that suction by the collection flow path is performed with the predetermined suction force D₀, a microparticle sorting procedure is executed in the microchip, and as a result of executing the sorting procedure, an emulsion that has passed through an emulsion detection region in the collection flow path is detected and the number of emulsions is counted.

In the emulsion counting step S1901, the number of emulsions is counted that have passed through the emulsion detection region in the collection flow path. For example, in the emulsion counting step S1901, as a result of performing the microparticle sorting procedure on a known number of emulsions, the number of emulsions is counted that have passed through the emulsion detection region in the collection flow path. Counting the number of the emulsions may be performed in the emulsion detection region in the collection flow path. For example, the number of emulsions can be counted by detection of passage through the emulsion detection region in the collection flow path. An example of the emulsion detection region provided in the collection flow path is the emulsion detection region 164 illustrated in FIG. 5, for example. As illustrated in FIG. 5, the emulsion passes through the emulsion detection region 164 provided in the collection flow path 159, whereby scattered light is emitted from the emulsion. The scattered light is detected, whereby the number of emulsions sucked into the collection flow path 159 can be counted.

### (2) Step S1902 of Repeating Emulsion Counting Step

In the repeating step S1902 of FIG. 19, the emulsion counting step can be repeated in the same manner except that the suction force D₀ is changed to various larger and/or smaller suction forces Dₙ. Preferably, in the repeating step S1902 of FIG. 19, the emulsion counting step S1901 can be repeated in the same manner except that the suction force D₀ is changed to various small suction forces Dₙ. The suction forces Dₙ can be appropriately set by one skilled in the art in consideration of factors such as, for example, a specification of a suction means provided on the collection flow path, the size of the microchip, a region covered by a predetermined suction force in a case where the suction force is applied, and/or tolerance. In the repeating step S1902, the emulsion counting step is performed for each of the various suction forces Dₙ, whereby the number of emulsions sucked into the collection flow path is obtained for each of the various suction forces Dₙ.

For example, the various suction forces Dₙ can be suction forces obtained by increasing or decreasing the D₀ stepwise at a predetermined rate. The predetermined rate can be, for example, 0.01 to 30%, particularly 0.1% to 25%, more particularly 1 to 20%, and still more particularly 1 to 10%. The number of steps for increasing or decreasing the D₀ can be, for example, 3 to 20 steps, particularly 4 to 15 steps, and more particularly 5 to 10 steps. For example, in a case where the various suction forces Dₙ are obtained by decreasing the D₀ by four steps by 20%, the various suction forces Dₙ are (D₀−D₀×20%), (D₀−D₀×20%×2), (D₀−D₀×20%×3), and (D₀−D₀×20%×4). In this case, the emulsion counting step can be performed in each of a total of five suction forces including the D₀.

Furthermore, the number of steps of increasing the D₀ and the number of steps of decreasing the D₀ may be the same as each other or different from each other. Furthermore, the various suction forces Dₙ may be obtained only by increasing the D₀, or may be obtained only by decreasing the D₀. The number of steps of increasing the D₀ and the number of steps of decreasing the D₀ can be appropriately set according to a value of the D₀. Furthermore, for each of the various suction forces Dₙ, the emulsion counting step may be performed a plurality of times, for example, two to five times, particularly two to three times.

### (3) Step S1903 of Determining Suction Force

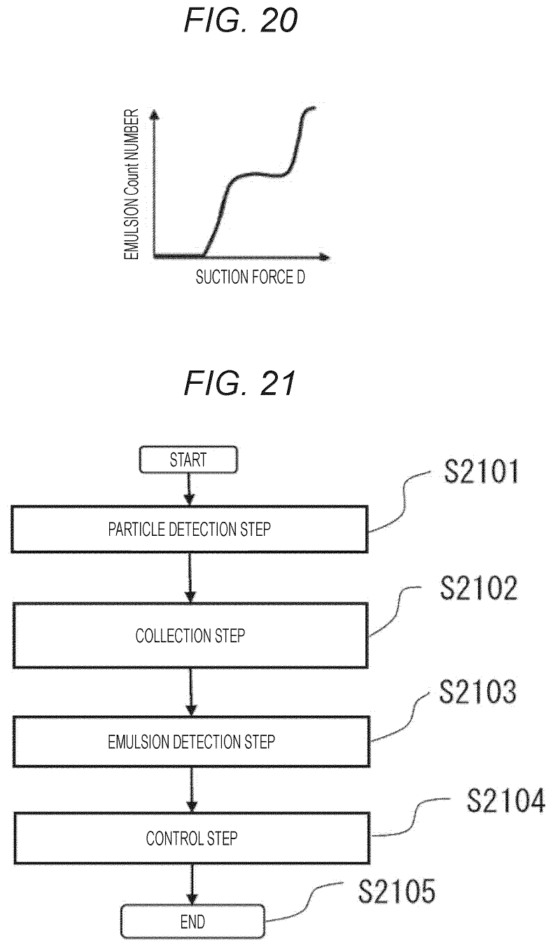

In step S1903 of determining the suction force that should be applied in FIG. 19, from the number of emulsions sucked into the collection flow path in each of the various suction forces Dₙ as illustrated in FIG. 20, the suction force D in a case where the number is closest to the predetermined number of emulsions and the suction force is the smallest can be determined as the suction force that should be applied.

Alternatively, both the signal intensity (area signal, peak signal, width signal) of the forward-scattered light of the emulsion and the counted number of the emulsions may be used to determine the suction force that should be applied. Furthermore, the determination can be automatically performed by, for example, a control unit incorporating a predetermined program, and the like.

In the microparticle sorting method of the present embodiment, after the suction force determination step and the step of determining a time at which suction is performed are performed, the sorting procedure for a sample containing the sorting-target microparticle is performed; however, while the sorting procedure is performed, or as appropriate, whether the sorting procedure is normally performed by performing the emulsion counting step and the microparticle counting step may be monitored, by an information processing unit that integrates information regarding the microparticle detected by the particle detection unit and information regarding the microparticle in the emulsion detected by the emulsion detection unit.

### 6. Sixth Embodiment (Microparticle Sorting Method in Microparticle Sorting Device)

A microparticle sorting method in the microparticle sorting device according to the present technology includes a particle detection step, a collection step, an emulsion detection step, and a control step. The microparticle sorting method according to the present embodiment will be described below with reference to FIG. 21. FIG. 21 illustrates a flowchart of the microparticle sorting method according to the embodiment of the present technology.

### (1) Particle Detection Step S2101

In a particle detection step S2101 in FIG. 21, a microparticle in the first liquid flowing through the main flow path is detected. In the particle detection step S2101 in the present embodiment, a procedure of detecting the microparticle in the first liquid flowing through the main flow path can be executed using the microparticle sorting device equipped with the microchip described in 1. described above. For example, in the number-of-particles counting step S1001 in the second embodiment, the microparticle is detected at a time point when the first liquid including the microparticle flowing on the main flow path passes through the particle detection region. Details of the detection of the microparticle are the same as the detection of the microparticle described in 1. described above and 2. described above. For that reason, the description of these is omitted.

### (2) Collection Step S2102

In a collection step S2102 of FIG. 21, an emulsion in which a sorting-target microparticle among the microparticles and the first liquid are contained in the second liquid immiscible with the first liquid is collected downstream of a position where the microparticles are detected. In the collection step S2102 in the present embodiment, a procedure of collecting the a sorting-target microparticle among the microparticles can be executed using the microparticle sorting device equipped with the microchip described in 1. described above. For example, in the number-of-particles counting step S1001, the step S1002 of repeating the number-of-particles counting step, and the step S1003 of determining a time at which suction should be performed in the second embodiment, the sorting-target microparticle among the microparticles is sucked from the main flow path into the collection flow path with the predetermined suction force by the collection flow path, whereby the sorting-target microparticle is collected in the second liquid in the collection flow path in a state of being contained in the first liquid, and collection as an emulsion is achieved. Details of collection of the sorting-target microparticle are as described in 1. described above and 2. described above. For that reason, the description of these is omitted.

### (3) Emulsion Detection Step S2103

In an emulsion detection step S2103 in FIG. 21, light from the emulsion collected and/or a microparticle contained in the emulsion is detected using different optical detection systems. In the emulsion detection step S2103 in the present embodiment, a procedure of detecting light from the emulsion can be executed using the microparticle sorting device equipped with the microchip described in 1. described above. For example, in the number-of-particles counting step S1001, the step S1002 of repeating the number-of-particles counting step, and the step S1003 of determining a time at which suction should be performed in the second embodiment, light irradiation is performed to the emulsion in the emulsion detection region located downstream of the particle sorting section, and light generated by the light irradiation is detected by the emulsion detection unit using the different optical detection systems. At least one of the different optical detection systems detects scattered light. Details of the emulsion detection are as described in 1. described above and 2. described above. In the emulsion detection step S2103 in the present embodiment, a procedure of detecting light from the microparticle contained in the emulsion can be executed using the microparticle sorting device equipped with the microchip described in 1. described above. For example, in the number-of-particles counting step S1001, the step S1002 of repeating the number-of-particles counting step, and the step S1003 of determining a time at which suction should be performed in the second embodiment, light irradiation is performed to the emulsion in the emulsion detection region located downstream of the particle sorting section, and scattered light and fluorescence generated by the light irradiation are detected by the emulsion detection unit using the different optical detection systems. At least one of the different optical detection systems detects scattered light. Details of the emulsion detection are as described in 1. described above and 2. described above.

### (4) Control Step S2104

In a control step S2104 of FIG. 21, collection (sorting) of the sorting-target microparticle is controlled on the basis of information on the light detected in the emulsion detection step. In the control step S2104 in the present embodiment, a procedure of controlling the collection (sorting) of the sorting-target microparticle can be executed using the microparticle sorting device equipped with the microchip described in 1. described above. For example, in the number-of-particles counting step S1001, the step S1002 of repeating the number-of-particles counting step, and the step S1003 of determining a time at which suction should be performed in the second embodiment, the control unit controls the collection (sorting) of the sorting-target microparticle on the basis of the information on the light detected in the emulsion detection step. More specifically, for example, control of the collection (sorting) is achieved by adjusting the sorting delay time that is a time from detection of the microparticle in the particle detection unit to suction of the microparticle in the particle sorting section, or the suction force in the particle sorting section. Details of the control of the collection (sorting) are as described in 1. described above and 2. described above.

Furthermore, the present technology also provides a program for causing a computer to execute the suction force determination step and the step of determining a time at which suction should be performed. The computer corresponds to the microparticle sorting device described in 1. described above, and particularly corresponds to the control unit included in the device. Furthermore, the present technology also provides a microparticle sorting method including executing the suction force determination step and the step of determining a time at which suction should be performed described above.

Note that the present technology may also have following configurations.
[1]

A microparticle sorting device including:
a particle detection unit that detects microparticles in a first liquid flowing through a main flow path;
a collection flow path that collects an emulsion in which a sorting-target microparticle among the microparticles and the first liquid are contained in a second liquid immiscible with the first liquid;
an emulsion detection unit that detects light from the emulsion collected and/or microparticles contained in the emulsion by using different optical detection systems; and
a control unit that controls collection of the emulsion into the collection flow path on the basis of information detected by the emulsion detection unit.
[2]

The microparticle sorting device according to [1], in which
the collection flow path includes:
a pressure chamber provided in the midway of the collection flow path; and
an actuator that operates at a time of sorting the microparticles and increases a volume of the pressure chamber by a certain amount.
[3]

The microparticle sorting device according to [1] or [2], in which the control unit adjusts a sorting delay time that is a time from detection of the microparticles in the particle detection unit to suction of the microparticles in the collection flow path, or a suction force that is strength of suction in the collection flow path, on the basis of information on light detected by the emulsion detection unit.
[4]

The microparticle sorting device according to [2], in which the actuator is a piezoelectric element, and the suction force is adjusted by a drive waveform of the piezoelectric element or a drive voltage of the piezoelectric element.
[5]

The microparticle sorting device according to any one of [1] to [4], in which in the emulsion detection unit, at least one of the different optical detection systems detects scattered light.
[6]

The microparticle sorting device according to [5], in which the scattered light is any of forward-scattered light, back-scattered light, or side-scattered light.
[7]

The microparticle sorting device according to any one of [1] to [6], in which in the emulsion detection unit, at least one of the different optical detection systems detects fluorescence.
[8]

The microparticle sorting device according to [7], in which a plurality of pieces of the fluorescence detected by the optical detection systems has an identical or a plurality of wavelengths.
[9]

The microparticle sorting device according to any one of [1] to [8], in which the emulsion detection unit detects information regarding the emulsion on the basis of forward-scattered light.
[10]

The microparticle sorting device according to any one of [1] to [9], in which the emulsion detection unit detects information regarding presence or absence of a microparticle in the emulsion on the basis of at least one of fluorescence, back-scattered light, or side-scattered light.
[11]

The microparticle sorting device according to [3], in which the control unit changes the sorting delay time, counts the number of microparticles in the emulsion detected by the emulsion detection unit, and determines, as an optimal sorting delay time, a sorting delay time in which a counted number of the microparticles in the emulsion is a predetermined value.
[12]

The microparticle sorting device according to [11], in which a maximum value of the counted number of the microparticles in the emulsion is set as the predetermined value.
[13]

The microparticle sorting device according to [3], in which the control unit changes the suction force, calculates a signal intensity of forward-scattered light detected by the emulsion detection unit, and determines a suction force having a predetermined signal intensity as an optimal suction force.
[14]

The microparticle sorting device according to [13], in which the signal intensity is any of an area signal, a peak signal, and a width signal.
[15]

The microparticle sorting device according to [3], in which the control unit changes the suction force, counts the number of the emulsions detected by the emulsion detection unit, and determines, as an optimal suction force, a suction force with which a counted number of the emulsions is a predetermined value.
[16]

The microparticle sorting device according to [3], in which the control unit determines an optimal suction force on the basis of both a signal intensity of the forward-scattered light detected by the emulsion detection unit and a counted number of the emulsions.
[17]

The microparticle sorting device according to any one of [1] to [16], further including an information processing unit that integrates information regarding the microparticles detected by the particle detection unit and information regarding microparticles in the emulsion detected by the emulsion detection unit.
[18]

A microparticle sorting method including:
a particle detection step of detecting microparticles in a first liquid flowing through a main flow path;
a collection step of collecting an emulsion in which a sorting-target microparticle among the microparticles and the first liquid are contained in a second liquid immiscible with the first liquid;
an emulsion detection step of detecting light from the emulsion collected and/or microparticles contained in the emulsion by using different optical detection systems; and
a control step of controlling collection of the emulsion in the collection step on the basis of information detected in the emulsion detection step.
[19]

A microparticle sorting method including:
an emulsion detection step of sucking a first liquid containing microparticles with a predetermined suction force by a collection flow path from a main flow path communicating with the collection flow path into the collection flow path, generating an emulsion in which a sorting-target microparticle among the microparticles and the first liquid are contained in a second liquid immiscible with the first liquid, and acquiring a signal intensity of light from the emulsion or counting the number of emulsions generated;
a suction force determination step of determining a suction force for sucking the first liquid into the collection flow path on the basis of the signal intensity acquired or the number of emulsions generated;
a number-of-particles counting step of sucking the first liquid containing the sorting-target microparticle among the microparticles into the collection flow path with the suction force determined in the suction force determination step and counting the number of the sorting-target microparticles sucked into the collection flow path; and
a step of determining a time at which suction is to be performed, on the basis of the number of the sorting-target microparticles counted, the step determining an elapsed time from passage through a predetermined position of the main flow path, the elapsed time being a time with which suction by the collection flow path is to be performed.

### REFERENCE SIGNS LIST

100 Microparticle sorting device
101 First light irradiation unit
102 Particle detection unit
103 Control unit
105 Determination unit
108 Emulsion detection unit
109 Second light irradiation unit
150 Microparticle sorting microchip

1. A microparticle sorting device comprising:
a particle detection unit that detects microparticles in a first liquid flowing through a main flow path;
a collection flow path that collects an emulsion in which a sorting-target microparticle among the microparticles and the first liquid are contained in a second liquid immiscible with the first liquid;
an emulsion detection unit that detects light from the emulsion collected and/or microparticles contained in the emulsion by using different optical detection systems; and
a control unit that controls collection of the emulsion into the collection flow path on a basis of information detected by the emulsion detection unit.

2. The microparticle sorting device according to claim 1, wherein
the collection flow path includes:
a pressure chamber provided in a midway of the collection flow path; and
an actuator that operates at a time of sorting the microparticles and increases a volume of the pressure chamber by a certain amount.

3. The microparticle sorting device according to claim 2, wherein the control unit adjusts a sorting delay time that is a time from detection of the microparticles in the particle detection unit to suction of the microparticles in the collection flow path, or a suction force that is strength of suction in the collection flow path, on a basis of information on light detected by the emulsion detection unit.

4. The microparticle sorting device according to claim 3, wherein the actuator is a piezoelectric element, and the suction force is adjusted by a drive waveform of the piezoelectric element or a drive voltage of the piezoelectric element.

5. The microparticle sorting device according to claim 1, wherein in the emulsion detection unit, at least one of the different optical detection systems detects scattered light.

6. The microparticle sorting device according to claim 5, wherein the scattered light is any of forward-scattered light, back-scattered light, or side-scattered light.

7. The microparticle sorting device according to claim 1, wherein in the emulsion detection unit, at least one of the different optical detection systems detects fluorescence.

8. The microparticle sorting device according to claim 7, wherein a plurality of pieces of the fluorescence detected by the optical detection systems has an identical or a plurality of wavelengths.

9. The microparticle sorting device according to claim 1, wherein the emulsion detection unit detects information regarding the emulsion on a basis of forward-scattered light.

10. The microparticle sorting device according to claim 1, wherein the emulsion detection unit detects information regarding presence or absence of a microparticle in the emulsion on a basis of at least one of fluorescence, back-scattered light, or side-scattered light.

11. The microparticle sorting device according to claim 3, wherein the control unit changes the sorting delay time, counts a number of microparticles in the emulsion detected by the emulsion detection unit, and determines, as an optimal sorting delay time, a sorting delay time in which a counted number of the microparticles in the emulsion is a predetermined value.

12. The microparticle sorting device according to claim 11, wherein a maximum value of the counted number of the microparticles in the emulsion is set as the predetermined value.

13. The microparticle sorting device according to claim 3, wherein the control unit changes the suction force, calculates a signal intensity of forward-scattered light detected by the emulsion detection unit, and determines a suction force having a predetermined signal intensity as an optimal suction force.

14. The microparticle sorting device according to claim 13, wherein the signal intensity is any of an area signal, a peak signal, and a width signal.

15. The microparticle sorting device according to claim 3, wherein the control unit changes the suction force, counts a number of the emulsions detected by the emulsion detection unit, and determines, as an optimal suction force, a suction force with which a counted number of the emulsions is a predetermined value.

16. The microparticle sorting device according to claim 3, wherein the control unit determines an optimal suction force on a basis of both a signal intensity of the forward-scattered light detected by the emulsion detection unit and a counted number of the emulsions.

17. The microparticle sorting device according to claim 1, further comprising an information processing unit that integrates information regarding the microparticles detected by the particle detection unit and information regarding microparticles in the emulsion detected by the emulsion detection unit.

18. A microparticle sorting method comprising:
a particle detection step of detecting microparticles in a first liquid flowing through a main flow path;
a collection step of collecting an emulsion in which a sorting-target microparticle among the microparticles and the first liquid are contained in a second liquid immiscible with the first liquid;
an emulsion detection step of detecting light from the emulsion collected and/or microparticles contained in the emulsion by using different optical detection systems; and
a control step of controlling collection of the emulsion in the collection step on a basis of information detected in the emulsion detection step.

19. A microparticle sorting method comprising:
an emulsion detection step of sucking a first liquid containing microparticles with a predetermined suction force by a collection flow path from a main flow path communicating with the collection flow path into the collection flow path, generating an emulsion in which a sorting-target microparticle among the microparticles and the first liquid are contained in a second liquid immiscible with the first liquid, and acquiring a signal intensity of light from the emulsion or counting a number of emulsions generated;
a suction force determination step of determining a suction force for sucking the first liquid into the collection flow path on a basis of the signal intensity acquired or the number of emulsions generated;
a number-of-particles counting step of sucking the first liquid containing the sorting-target microparticle among the microparticles into the collection flow path with the suction force determined in the suction force determination step and counting a number of the sorting-target microparticles sucked into the collection flow path; and
a step of determining a time at which suction is to be performed, on a basis of the number of the sorting-target microparticles counted, the step determining an elapsed time from passage through a predetermined position of the main flow path, the elapsed time being a time with which suction by the collection flow path is to be performed.
